(19) United States
(12) Patent Application Publication
(10) Pub. No.: US 2006/0134333 A1
(43) Pub. Date: Jun. 22, 2006

(54) Protective layer forming material coating system

(76) Inventor: Bansei Nagase, Sayama-shi (JP)

Correspondence Address: FISH & RICHARDSON P.C., P.O. BOX 1022, MINNEAPOLIS, MN, 55440-1022, US

(21) Appl. No.: 10/548,896

(22) PCT Filed: Mar. 12, 2004
(86) PCT No.: PCT/JP04/03281

§ 371 Date: Sep. 9, 2005

(30) Foreign Application Priority Data
Mar. 14, 2003 (JP) 2003-070151
Mar. 14, 2003 (JP) 2003-070213
Mar. 31, 2003 (JP) 2003-096142
Apr. 14, 2003 (JP) 2003-109372
Jun. 19, 2003 (JP) 2003-174874

(51) Int. Cl. B05D 3/00

(52) U.S. Cl. 427/299; 118/209

(57) ABSTRACT

A robot capable of teaching operation is installed in the vicinity of a transfer line in which a plurality of vehicles are successively transferred. The robot is provided with a roller which is rotatable and made of a material capable of absorbing and storing a protective layer forming material. A controller for controlling the robot receives a production control information from a production control information supply section and recognizes the number of coating-unnecessary vehicles continuously transferred, on the basis of production control information (step S201). When the number of coating-unnecessary vehicles successively transferred is three or more, the roller is moistened (step S203). When the number of coating-unnecessary vehicles successively transferred becomes two, moistening is terminated and a preparatory operation is performed (step S207).

### TECHNICAL FIELD

The present invention relates to a method of and an apparatus for applying a protective layer forming material to an outer surface which comprises primarily a painted area of a motor vehicle that has been painted, and more particularly to a method of and an apparatus for applying a protective layer forming material in a liquid form which will act as a peelable protective layer after being dried.

### BACKGROUND ART

After being manufactured, vehicles such as automobiles are often stored in an outdoor stockyard or transported by a trailer, a ship, or the like until they are handed over to users. Since the vehicles are exposed to dust, metal particles, salt, oil, acid, direct sunlight, etc. while they are in storage or transportation, the surface layer of a plurality of coating layers on the outer surface of the vehicles tends to become lower in quality. To prevent the surface layer from being deteriorated, there is known a process of forming a peelable protective layer on the painted area before the vehicle is shipped out (see, for example, Japanese Laid-Open Patent Publication No. 2001-89697). The peelable protective layer is formed by applying and drying a protective layer forming material (also called “strippable paint”) which is a liquid wrap material, and can protect the painted area. The protective layer forming material can easily be peeled off when it is to be removed, and is not peeled off of its own when in normal storage.

For applying the protective layer forming material to be dried into the peelable protective layer, the protective layer forming material is applied to rollers, and the rollers are rolled by a plurality of workers to coat the surface layer with the protective layer forming material.

In order to automate the coating process, reduce the burden on the workers and uniformize the coating quality, there has been proposed a process of pouring a protective layer forming material onto a body and applying air to spread the protective layer forming material (see, for example, Japanese Laid-Open Patent Publication No. 8-173882). According to the proposed process, many steps of a process of applying the protective layer forming material are automated to lower the burden on the workers and increase the tact time.

As modern factories manufacture a large variety of products, one conveyor line may be compatible with a plurality of vehicle types, and one vehicle type may have different detail configurations. For manufacturing certain pre-ordered vehicles, they need to be distinguished from other general vehicles when they are being manufactured. In order to accurately perform a complex control process for operating such a conveyor line, there has been proposed a system for automatically generating a daily executed manufacturing plan file and production management information based on a monthly order file from a host computer, and transmitting the daily executed manufacturing plan file and production management information to control computers in respective stations (see, for example, Japanese Laid-Open Patent Publication No. 9-141531).

According to the process disclosed in Japanese Laid-Open Patent Publication No. 8-173882, the protective layer forming material is not necessarily spread uniformly. The disclosed process is not applied to roof edges in order to prevent the protective layer forming material from being scattered.

Recent vehicle bodies are becoming more complex in shape, and some of them have convexities and concavities and complex and delicate curved surfaces. It is difficult to spread the protective layer forming material with an air nozzle on such convexities and concavities and curved surfaces. Furthermore, though it is necessary to apply the protective layer forming material to a greater thickness in areas where the coating quality is of particular importance, it is difficult to adjust the thickness of the coating film when the protective layer forming material is spread by an air nozzle.

Consequently, after the protective layer forming material is spread by an air nozzle, several workers are required to coat small spots such as roof edges, convexities and concavities, etc. with the protective layer forming material and finish the coating, using a roller. The process of applying the protective layer forming material is thus performed partly manually, is burdensome on the workers, and results in different coating quality levels depending on how the workers are skilled.

In order to reduce the burden on the workers and uniformize the job quality levels, the roller that has heretofore been used by the workers may be operated by industrial robots. The roller should preferably be automatically supplied with the protective layer forming material by a pump. One process of supplying the roller with the protective layer forming material is to supply the protective layer forming material to the roller from an inner surface thereof, so that the protective layer forming material seeps out to the surface of the roller. According to this process, the protective layer forming material appropriately seeps substantially uniformly into the roller.

When the protective layer forming material is supplied to the roller from the inner surface thereof, it takes some time until the protective layer forming material seeps out to the entire surface of the roller, and the protective layer forming material may not necessarily seep sufficiently uniformly to the surface of the roller. Therefore, it takes some time until the actual operation is started, and coating irregularities of the protective layer forming material may be developed or the coating thickness of the protective layer forming material may be insufficient.

As described above, since vehicles have a complex shape, coating irregularities may be developed depending on the coated area if the protective layer forming material are applied under the same conditions. For example, the protective layer forming material tends to sag in a largely inclined area, and tends to be supplied insufficiently, causing a coating thickness shortage or thin coating spots, in a wide area.

In recent vehicle production factories, it is customary to produce vehicles that are customized to specifications requested by certain users. If a user-customized vehicle (hereinafter referred to as “back-ordered vehicle”) is manufactured, then the vehicle is handed over to the user immediately after it is manufactured, and hence any deterioration of the coating layer quality before the produced vehicle is delivered is very small. Therefore, such back-ordered vehicles do not need to be coated with the protective layer forming material, and when a back-ordered vehicle is conveyed in, the coating process is suspended. At this time, the protective layer forming material needs to stop being supplied to the roller. If a certain number of back-ordered vehicles are conveyed successively, then the protective layer forming material that remains in the roller is liable to be dried and solidified. Therefore, the dried and solidified protective layer forming material is liable to clog the pipe for supplying the protective layer forming material and deteriorate the roller.

The workers can visually recognize the shapes of vehicles when they are to be coated with the protective layer forming material. However, if robots are employed, then some means are required to distinguish vehicle types and perform different coating processes for the respective vehicle types.

In factories for producing vehicles, it is customary to temporarily cover vehicle bodies with resin-made covers known as scratch covers to prevent the vehicle bodies from being damaged during the assembling process. A scratch cover is temporarily applied to a front lateral surface of a vehicle body, and removed before the vehicle is shipped out. It is necessary to prepare scratch covers having different shapes for different vehicle types, and also to prepare a large number of scratch covers depending on the number of vehicles to be produced day by day on the conveyor line.

In view of the demands for coating process automation and coating quality uniformization, the present applicant has proposed a coating system and a coating method for a protective layer forming material as disclosed in Japanese Patent Application No. 2002-381880. According to Japanese Patent Application No. 2002-381880, the process of coating the outer surface of a vehicle with a protective layer forming material is automated by a roller operated by a robot for increasing the production efficiency, simplifying the job, and uniformizing the coating quality.

### DISCLOSURE OF THE INVENTION

It is an object of the present invention to provide a method of and a system for applying a protective layer forming material, the method and the system being capable of distinguishing workpieces to be coated with the protective layer forming material and workpieces not to be coated with the protective layer forming material, from each other, and of suspending a coating process while preventing the protective layer forming material remaining in a roller from being dried and solidified when workpieces not to be coated with the protective layer forming material are successively conveyed or when the coating process is suspended.

Another object of the present invention is to provide a method of and a system for applying a protective layer forming material, the method and the system being capable of quickly starting a process of applying the protective layer forming material and of preventing coating irregularities and a coating thickness shortage of the protective layer forming material.

Still another object of the present invention is to provide a method of and a system for applying a protective layer forming material, the method and the system being capable of appropriately applying the protective layer forming material depending on the locations to be coated which have various shapes and areas.

Yet still another object of the present invention is to provide a method of and a system for applying a protective layer forming material, the method and the system being capable of maintaining, over a long period of time, the performance of a roller which is held against a surface of a workpiece to coat the workpiece with the protective layer forming material.

A system for applying a protective layer forming material according to the present invention has a coating apparatus disposed near a conveying line for successively conveying a plurality of workpieces on carriages, the coating apparatus being operable based on teaching data, a roller mechanism connected to the coating apparatus and having a removable roller, a supply mechanism for supplying a protective layer forming material in a liquid form which will act as a peelable protective layer after being dried, a production management information supply for holding production management information representing the recorded relationship between information about each of the workpieces and operation of the conveying line, and a control console connected to the production management information supply, for receiving the production management information and controlling the coating apparatus, wherein the control console controls the coating apparatus based on the production management information.

By controlling the coating apparatus based on the production management information, the information of carriages and workpieces such as vehicles that are to be conveyed in can be recognized in advance, allowing appropriate responses and preparations to be made.

If the coating apparatus comprises a robot, and each of the workpieces comprises a vehicle, then they are advantageous in that the robot can be moved along complex shapes of the vehicle.

The production management information may include information indicative of the types of the workpieces, and the control console may select the teaching data based on the information indicative of the types of the workpieces, and operate the coating apparatus.

The types, e.g., vehicle types, of workpieces such as vehicles that are to be conveyed in can be recognized, allowing coating processes depending on the vehicle types to be performed.

The system may further comprise a water reservoir disposed in an operation range of the coating apparatus and storing a washing liquid, and a vapor generator for evaporating or atomizing the washing liquid stored in the water reservoir, wherein the production management information may include information indicative of whether the protective layer forming material is to be applied to each of the workpieces or the carriages, and the production management information supply or the control console may determine a process suspension time to suspend a coating process for applying the protective layer forming material based on the production management information, and, if the process suspension time is equal to or greater than a predetermined value, may control the vapor generator to evaporate or atomize the washing liquid in the water reservoir and apply generated vapor to the roller to humidify the roller.

The process suspension time can be determined based on the production management information. If the process suspension time is long, then a humidifying process is performed, so that the coating process may be suspended without drying and solidifying the protective layer forming material remaining in the roller.

The control console may recognize the number of successively conveyed workpieces or carriages which are not to be coated with the protective layer forming material, based on the production management information, and may determine the process suspension time based on the recognized number. The process suspension time can easily be determined based on the number of workpieces.

The system may further comprise a planar surface on which the roller rolls, the planar surface being disposed in the operation range of the coating apparatus and wider than a longitudinal width of the roller, wherein the control console may determine a process resumption time until the coating process is resumed based on the production management information, and, if the process resumption time is equal to or smaller than a predetermined value, may move the roller from the vapor generator to the planar surface, and roll the roller on the planar surface while supplying the protective layer forming material to the roller.

The process resumption time is determined based on the production management information. If the process resumption time is short, an immersing process and a rolling process are performed to prepare the coating process for applying the protective layer forming material.

If the vapor generator comprises an ultrasonic vibrator which is vibratable for evaporating or atomizing the washing liquid, then vapor can quickly be generated. Therefore, the roller can quickly be humidified. If the roller is not to be humidified, then the vapor generator may be inactivated.

The supply mechanism may have a pressure control valve for controlling the pressure of the protective layer forming material supplied to the roller, and the control console may supply the protective layer forming material while changing the pressure of the protective layer forming material when the workpieces are coated with the protective layer forming material.

By thus supplying the protective layer forming material while changing the pressure of the protective layer forming material when the workpieces are coated with the protective layer forming material, the protective layer forming material may be applied appropriately depending on locations having various shapes and areas.

If a surface of the workpieces which is to be coated with the protective layer forming material is divided into a plurality of coating areas, and the control console controls the pressure of the protective layer forming material with respect to each of the coating areas, then the process of setting and controlling the pressure to supply the protective layer forming material is facilitated.

If the control console controls respective times to supply the protective layer forming material to the coating areas, then the flexibility with which to set the quantity to be supplied of the protective layer forming material is increased.

The workpieces conveyed by the conveying line may have a plurality of types, and the control console may have an identifier for identifying the types of the workpieces, and a recorder for recording information about the division of the coating areas and pressures to supply the protective layer forming material for the respective coating areas, with respect to each of the types of the workpieces, wherein the control console may identify the types of the workpieces with the identifier, read the information corresponding to the types, and control the pressures to supply the protective layer forming material.

Since the control console identifies the types of the workpieces to be conveyed in with the identifier, reads the information about the division of the coating areas and the information about the pressures to supply the protective layer forming material for the respective coating areas, depending on the types of the workpieces, the various workpieces can appropriately be coated with the protective layer forming material.

The roller may comprise an outer protective layer forming material absorbing and holding member, a pipe disposed axially and having a plurality of holes defined in an outer circumferential surface thereof for supplying the protective layer forming material, and a hollow cylindrical collar disposed between the protective layer forming material absorbing and holding member and the pipe, wherein the collar may have conductive holes for leading the protective layer forming material supplied from the holes in the pipe to the protective layer forming material absorbing and holding member.

As the collar is provided, the roller has a very small space therein for the protective layer forming material to be kept therein. Therefore, the protective layer forming material that is supplied from the pipe quickly reaches the protective layer forming material absorbing and holding member for being applied to the workpiece. Consequently, changes that are caused in the supply pressure are quickly reflected in the coating process for performing an appropriate coating process on each of the coating areas.

A method of applying a protective layer forming material according to the present invention comprises the first step of applying the protective layer forming material to workpieces, using a coating apparatus disposed near a conveying line for successively conveying a plurality of workpieces on carriages, the coating apparatus being operable based on teaching data, a roller mechanism connected to the coating apparatus and having a removable roller, and a supply mechanism for supplying the protective layer forming material in a liquid form which will act as a peelable protective layer after being dried, the second step of removing the roller from the roller mechanism after the first step is finished, the third step of immersing the roller removed from the roller mechanism into a washing liquid, the fourth step of washing the roller immersed in the washing liquid, with the washing liquid, the fifth step of removing the washing liquid from the roller which has been washed with the washing liquid, the sixth step of drying the roller, and the seventh step of reinstalling the roller which has been dried on the roller mechanism.

As described above, after the coating process of applying the protective layer forming material to a workpiece is finished, the roller is immersed in the washing liquid and washed with the washing liquid, so that any deterioration of the roller can be suppressed as much as possible. Therefore, the performance of the roller can be maintained for a long period of time. As a result, the roller can have a longer service life.

If a cycle of the first through seventh steps is performed concurrently for a plurality of rollers while keeping the steps out of synchronism with each other, the coating apparatus does not need to wait until the steps of washing and drying the roller are finished, and the washed and dried roller may be installed to continue the coating process.

A cycle of the first through seventh steps may be performed within 72 hours. Since the roller is periodically washed, the performance of the roller can be maintained for a longer period of time.

In the fourth step, the roller may be washed with the washing liquid and washed with an auxiliary washing liquid which is different from the washing liquid.

As described above, after the coating process of applying the protective layer forming material to a workpiece is finished, the roller is immersed in the washing liquid and washed with the washing liquid, and then washed with the auxiliary washing liquid. Because any deterioration of the roller can be suppressed as much as possible, the performance of the roller can be maintained for a long period of time. As a result, the roller can have a longer service life. If the protective layer forming material is applied as a semi-solid deposit on the roller, it can effectively be washed away.

The washing liquid may comprise water and the auxiliary washing liquid may comprise alcohol.

A planar surface on which the roller rolls, the planar surface being disposed in an operation range of the coating apparatus and wider than a longitudinal width of the roller, and a reservoir disposed in the operation range of the coating apparatus and storing the protective layer forming material, may be employed, and the first step may comprise the first substep of immersing the roller in the protective layer forming material stored in the reservoir, and the second substep of rolling the roller on the planar surface.

As described above, before the coating process of applying the protective layer forming material is performed, the roller is immersed in the protective layer forming material stored in the reservoir, and the roller is rolled on the planar surface. Therefore, the protective layer forming material can quickly be caused to seep into the roller. The workpiece is prevented from suffering coating irregularities of the protective layer forming material and coating thickness shortages.

The roller may be removably mounted on the coating apparatus, and the first substep and the second substep may be carried out again when the roller is replaced. The protective layer forming material can quickly seep into the roller even if the roller is an unused one or it has been washed, so that the material of the surface of the roller can be rendered soft.

While the first step is being carried out, the first substep and the second substep may be carried out again for a predetermined number of workpieces or at each predetermined time interval.

Because the first substep and the second substep are carried out again for a predetermined number of workpieces or at each predetermined time interval, the roller holds the protective layer forming material sufficiently at all times, and the workpiece is prevented from suffering coating irregularities of the protective layer forming material and coating thickness shortages.

The first substep and/or the second substep may be carried out while the protective layer forming material is being supplied from the supply mechanism to the roller. The protective layer forming material can thus seep more reliably into the roller.

If the planar surface and the reservoir comprise an integral container, then the roller operates simply and smoothly, making it less liable for the protective layer forming material from leaking or being scattered out.

If the planar surface is slanted and has a lower end smoothly joined to the reservoir, then the roller operates simply and smoothly, making it less liable for the protective layer forming material from leaking or being scattered out. Excessive protective layer forming material that seeps out when the roller rolls flows down the planar surface into the reservoir for reuse.

A water reservoir disposed in an operation range of the coating apparatus and storing the washing liquid may be employed, and in a suspension time after the roller is removed from the roller mechanism in the second step and until a replacing roller is installed on the roller mechanism, a protective layer forming material support port which is supplied with the protective layer forming material in a mount of the roller may be immersed in the washing liquid in the water reservoir.

By immersing the protective layer forming material support port in the washing liquid in the water reservoir, the protective layer forming material remaining in the pipe is prevented from being dried and solidified while the coating process is being suspended.

Furthermore, a water reservoir disposed in an operation range of the coating apparatus and storing the washing liquid, and a vapor generator for evaporating or atomizing the washing liquid stored in the water reservoir are employed, and in a predetermined suspension time in the first step, the roller is positioned above the liquid level of the washing liquid in the water reservoir, and the vapor generator evaporates or atomizes the washing liquid to humidify the roller.

By evaporating or atomizing the washing liquid with the vapor generator to humidify the roller, the protective layer forming material remaining in the roller is prevented from being dried and solidified while the coating process is being suspended.

If the protective layer forming material comprises an acrylic copolymer, then the painted areas of the workpiece can be protected more reliably, and the protective layer forming material can easily be peeled off when to be removed.

### BRIEF DESCRIPTION OF THE DRAWINGS

FIG. 1 is a perspective view of an apparatus for applying a protective layer forming material, which is used in a method of applying a protective layer forming material according to an embodiment of the present invention;

FIG. 2 is a front elevational view of the apparatus for applying a protective layer forming material according to the embodiment;

FIG. 3 is a perspective view of a robot, a roller mechanism mounted on the robot, a container, and a moisture box;

FIG. 4 is an enlarged perspective view of the roller mechanism;

FIG. 5 is a front elevational view, partly in cross section, of the roller mechanism;

FIG. 6 is a side elevational view of the roller mechanism;

FIG. 7 is an exploded perspective view of a portion of the roller mechanism;

FIG. 8 is a cross-sectional view of a portion of the roller mechanism;

FIG. 9 is a perspective view of the container;

FIG. 10 is a side elevational view, partly in cross section, showing the manner in which a roller is humidified in a water storage box of the moisture box;

FIG. 11 is a circuit diagram of a composite hydraulic and pneumatic circuit;

FIG. 12 is a view showing a roller setting menu displayed on a monitor screen;

FIG. 13 is a side elevational view, partly in cross section, showing the manner in which a holder is immersed in the water storage box of the moisture box;

FIG. 14 is a block diagram of a production system to which the apparatus for applying a protective layer forming material is connected;

FIG. 15 is a diagram showing production management information at a certain time;

FIG. 16 is a diagram showing production management information at the time four vehicles have been conveyed from the time when the production management information shown in FIG. 15 is received;

FIG. 17 is a diagram showing production management information at the time three vehicles have been conveyed from the time when the production management information shown in FIG. 16 is received;

FIG. 18 is a view illustrative of the positional relationship between the robot and the surface of a vehicle when the robot moves to the right;

FIG. 19 is a view illustrative of the positional relationship between the robot and the surface of the vehicle when the robot moves to the left;

FIG. 20 is a diagram of data recorded in a data recorder;

FIG. 21 is a block diagram of a control console and devices connected to the control console;

FIG. 22 is a view showing a supply quantity setting menu displayed on the monitor screen;

FIG. 23 is a perspective view showing coating areas into which a surface of a vehicle to be coated with the protective layer forming material is divided;

FIG. 24 is a diagram showing teaching data and supply quantity tables that are recorded in the data recorder;

FIG. 25 is a timing chart of showing pressures and times in which the protective layer forming material is supplied to the roller, for the respective coating areas;

FIG. 26 is a flowchart of a part of the method of applying a protective layer forming material according to the embodiment;

FIG. 27 is a flowchart of a suspension mode which is a part of the method of applying a protective layer forming material according to the embodiment;

FIG. 28 is a flowchart of a back-order mode which is a part of the method of applying a protective layer forming material according to the embodiment;

FIG. 29 is a perspective view showing a rubber cover mounted on an upper surface of the water storage box of the moisture box;

FIG. 30 is a perspective view of a preparing mechanism which is used instead of the container; and

FIG. 31 is a block diagram illustrative of a process of cleaning the roller of the roller mechanism.

### BEST MODE FOR CARRYING OUT THE INVENTION

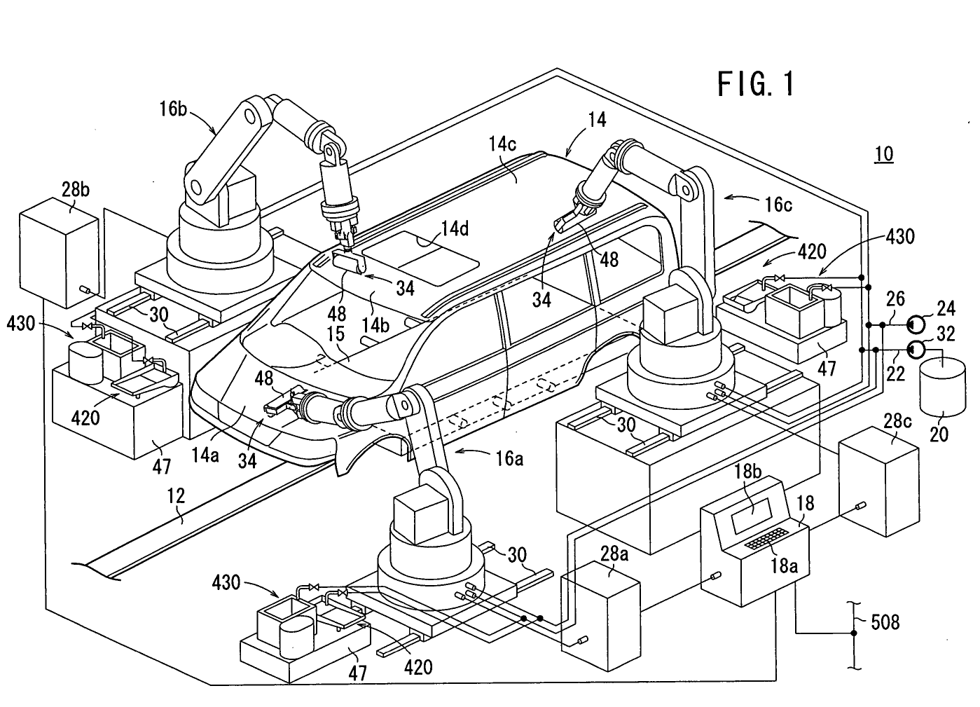

A preferred embodiment of a method of applying a protective layer forming material according to the present invention will be described below with reference to FIGS. 1 through 31 of the accompanying drawings.

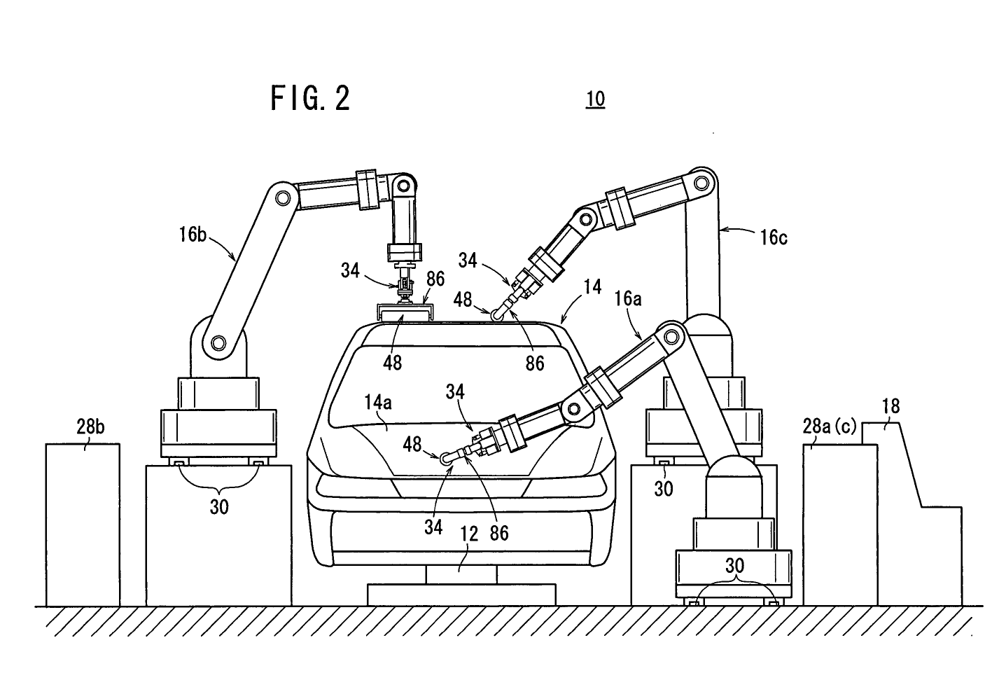

As shown in FIGS. 1 and 2, a coating system 10 used in the method of applying a protective layer forming material according to the embodiment is disposed on a conveying line 12 for vehicles (workpieces) 14, and coats a painted vehicle 14 with a protective layer forming material. The vehicle 14 is supported and conveyed by a carriage 15 movable on the conveying line 12. Usually, carriages 15 support and convey vehicles 14. However, idle carriages 15 with no vehicles 14 placed thereon may on rare occasions be conveyed along for factory operation reasons.

As shown in FIGS. 1 and 2, the coating system 10 has three robots (coating apparatus) 16a, 16b, 16c each comprising an industrial robot, a control console 18 for controlling the coating system 10 in its entirety, a tank 20 storing the protective layer forming material therein, a coating material pipe 22 extending from the tank 20 to the robots 16a, 16b, 16c, and a water pipe 26 for supplying water from a water source 24 to the robots 16a, 16b, 16c. The coating system 10 also includes a supply mechanism 150 and a conveying line control computer (production management information supply) 506 to be described later.

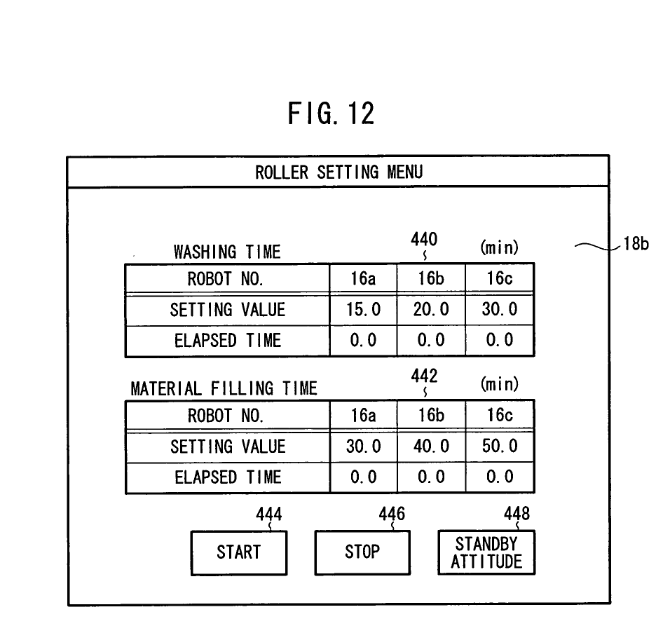

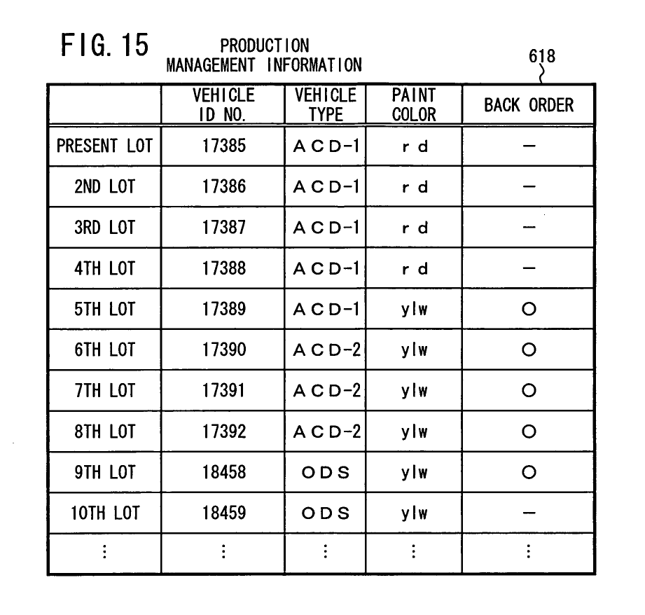

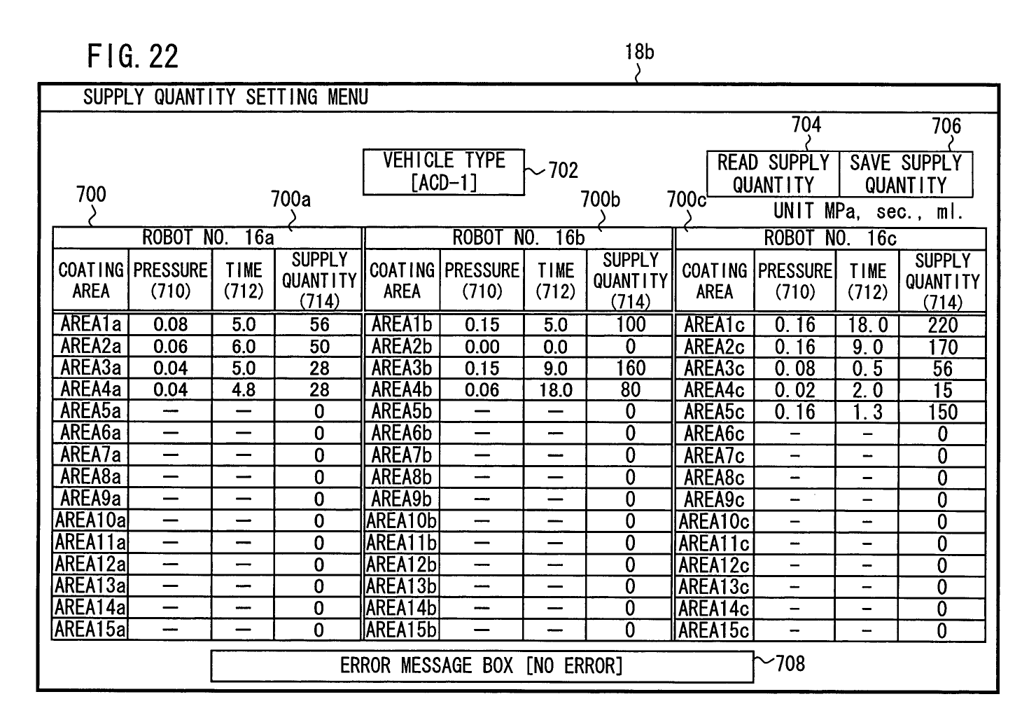

The robots 16a, 16b, 16c are controlled by respective robot controllers 28a, 28b, 28c that are connected to the control console 18. The control console 18 has an input device 18a such as a keyboard, a pointing device, etc., and a monitor screen 18b. The monitor screen 18b displays images representing a roller setting menu (see FIG. 12) and a supply quantity setting menu (see FIG. 22), to which data are input by the input device 18a. The control console 18 is connected to the conveying line control computer 506 which controls the conveying line 12. The conveying line control computer 506 is also connected to other computers than the control console 18 in respective stations disposed along the conveying line 12, and generates and supplies production management information 618 (see FIGS. 15 through 17) to the control console 18 and the computers. Details of the control console 18 will be described later.

The robots 16a, 16c are disposed on the left side of the conveying line 12 with respect to the conveying direction of the vehicle 14, and the robot 16b is disposed on the right side of the conveying line 12. The robots 16a is disposed in a front position, the robot 16b in a middle position, and the robot 16c in a rear position along the conveying direction of the vehicle 14. The robots 16a, 16b, 16c are movable on slide rails 30 parallel to the conveying line 12.

A pump 32 is connected to the coating material pipe 22 for drawing the protective layer forming material from the tank 20 and supplying the protective layer forming material to the robots 16a, 16b, 16c. The protective layer forming material is controlled to have a suitable temperature by a heater and a thermometer, not shown. The robots 16a, 16b, 16c have on their arm ends roller mechanisms 34 which are supplied with the protective layer forming material through the coating material pipe 22 and tubes 22a on its tip ends.

The protective layer forming material is chiefly made of an acrylic copolymer, and preferably includes two acrylic copolymers having different glass transition temperatures. Specifically, the protective layer forming material may be a protective layer forming material disclosed in Japanese Laid-Open Patent Publication No. 2001-89697 referred to above. The protective layer forming material has its viscosity adjustable depending on its ratio to water mixed therewith and temperature changes. When the protective layer forming material is dried, it is held in close contact with the vehicle 14 for chemically and physically protecting the painted area of the vehicle 14 from dust, metal particles, salt, oil, acid, direct sunlight, etc. The protective layer forming material can easily be peeled off if it is to be removed when the vehicle 14 is delivered to the user.

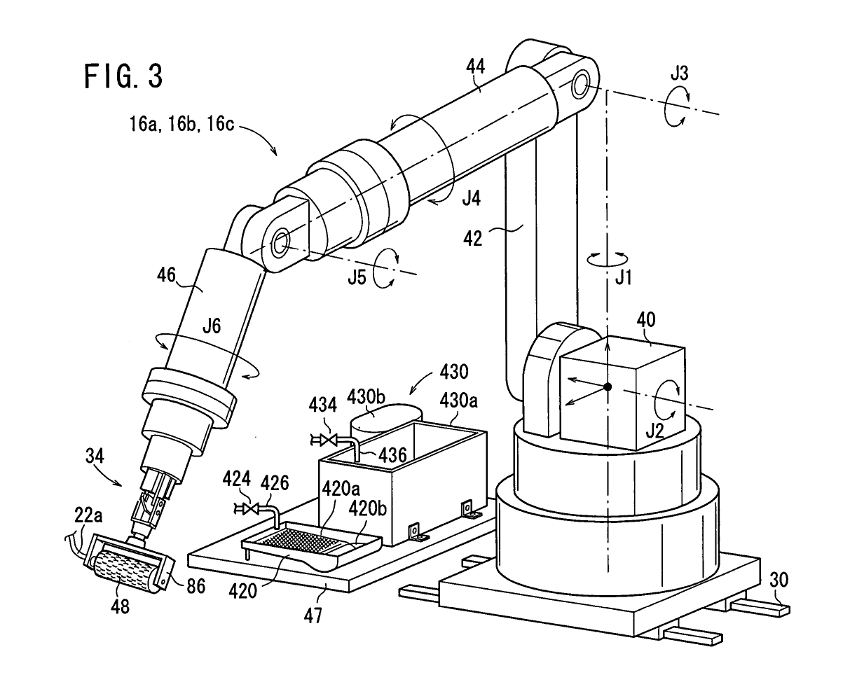

As shown in FIG. 3, each of the robots 16a, 16b, 16c comprises an industrial articulated robot, for example, and has a base 40, and a first arm 42, a second arm 44, and a third arm 46 which are successively extend from the base 40. The roller mechanism 34 is mounted on the tip end of the third arm 46, and operates as a so-called end effector. The first arm 42 is horizontally and vertically rotatable with respect to the base 40 about axes J1, J2. The second arm 44 is connected to the first arm 42 for rotation about an axis J3. The second arm 44 can be twisted about an axis J4. The third arm 46 is connected to the second arm 44 for rotation about an axis J5. The third arm 46 can be twisted about an axis J6.

The roller mechanism 34 connected to the tip end of each of the robots 16a, 16b, 16c can be moved to any desired position near the vehicle 14 and can be oriented in any direction by the movement of the 6-axis robot 16a, 16b, 16c. Stated otherwise, the roller mechanism 34 is movable with six degrees of freedom. The robots 16a, 16c, 16c may have actuators for making expansion and contraction, parallel link motion, etc., in addition to the rotation.

A container base 47 is disposed in the vicinity of each of the robots 16a, 16b, 16c. A flat container 420 and a moisture box 430 having an ultrasonic actuator circuit 430b are fixedly mounted on the container base 47. The container base 47 may be disposed in a moving range that can be reached by the roller 48. The relative positions of the containers 420 and the moisture boxes 430 with respect to the robots 16a, 16b, 16c are stored in the control console 18. Details of the container 420 and the moisture box 430 will be described later.

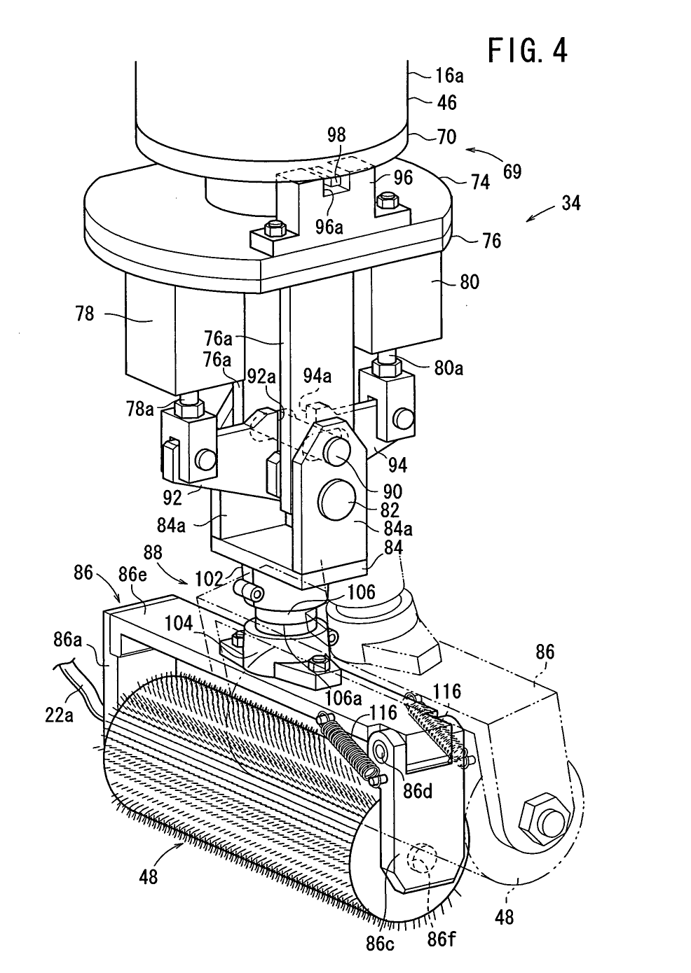

As shown in FIGS. 4 through 6, the roller mechanism 34 is mounted on the tip end of the third arm 46, and has a hollow cylindrical roller 48 made of a material capable of absorbing and holding the protective layer forming material, and a thrust rotating mechanism 69 serving as a mount installed on the third arm 46 of the robot 16a. The thrust rotating mechanism 69 comprises a mount member 70 attached to the third arm 46, a thrust rotating member 74 rotatably supported on the mount member 70 by a bearing 72, and a base 76 mounted on a lower surface of the thrust rotating member 74. The roller 48 is made of sponge, bristles, or the like, for example.

The roller mechanism 34 also has pneumatic cylinders 78, 80 mounted on respective opposite ends of the base 76, a swinging member 84 swingably supported on a swing shaft 82 on a substantially lower end of the base 76, and a holder connector 88 interconnecting a holder 86 which holds the roller 48 and the swing member 84. The roller 48 is radially swingable about the swing shaft 82. The swing member 84 has two upward extensions 84a extending upwardly therefrom, and a pin 90 is mounted on substantially upper ends of the upward extensions 84a parallel to the swing shaft 82. The pin 90 is disposed above the swing shaft 82.

Two downward extensions 76a extend downwardly from the base 76 and are disposed between the two upward extensions 84a. Pressing surfaces 92a, 94a are disposed between the two downward extensions 76a.

A rotation limiting member 96 is mounted on the thrust rotating member 74 and has a recess 96a defined in an upper surface thereof. A small tooth 98 that projects downwardly from the mount member 70 is disposed in the recess 96a. The small tooth 98 has a width smaller than the width of the recess 96a, providing a gap therebetween through which the thrust rotating member 74 is rotatable in a thrust direction. The thrust direction refers to a direction perpendicular to the axis of the roller 48 itself, and a direction about the axis of the third arm 46. The mount member 70 is fastened to the third arm 46 by a bolt 100 which may double as the small tooth 98.

The holder connector 88 has two upper and lower clamps 102, 104 confronting each other. These clamps 102, 104 hold an aluminum pipe 106 interconnecting the swing member 84 and the holder 86. The aluminum pipe 106 has an annular groove 106a defined in a surface thereof.

The roller 48 has opposite ends rotatably held by the holder 86. The tube 22a on the tip end of the coating material pipe 22 communicates with the interior of the roller 48 through an end of the holder 86. The roller 48 is removably mounted on the holder 86.

The roller mechanism 34 has the pneumatic cylinders 78, 80 mounted on the respective opposite ends of the base 76, the swinging member 84 swingably supported by the swing shaft 82 on the substantially lower ends of the two downward extensions 76a extending downwardly from the base 76, the holder 86 by which the roller 48 is held, and the holder connector 88 interconnecting the holder 86 and the swing member 84. The swing member 84 has the two upward extensions 84a extending upwardly, and the pin 90 is mounted on the substantially upper ends of the upward extensions 84a parallel to the swing shaft 82. The pin 90 is movably inserted in oblong holes 91 that are defined in the downward extensions 76a.

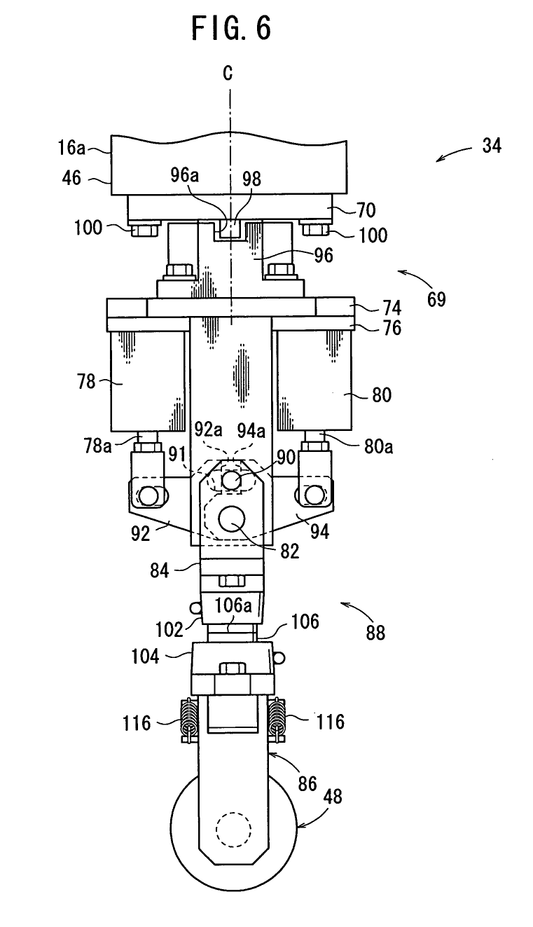

The roller mechanism 34 has two pin pressers 92, 94 rotatable about the swing shaft 82 under forces applied from respective rods 78a, 80a of the pneumatic cylinders 78, 80. The pressing surface 92a of the pin presser 92 presses the left surface of the pin 90 in FIG. 6 when the rod 78a is contracted, and the pressing surface 94a of the pin presser 94 presses the right surface of the pin 90 in FIG. 6 when the rod 80a is contracted.

The holder connector 88 has the two upper and lower clamps 102, 104 confronting each other. The clamp 102 is fixed to the swing member 84, and the clamp 104 is fixed to the holder 86. When the clamps 102, 104 hold the aluminum pipe 106, the swing member 84 and the holder 86 are interconnected. The aluminum pipe 106 has the annular groove 106a which serves as a split line for splitting the aluminum pipe 106.

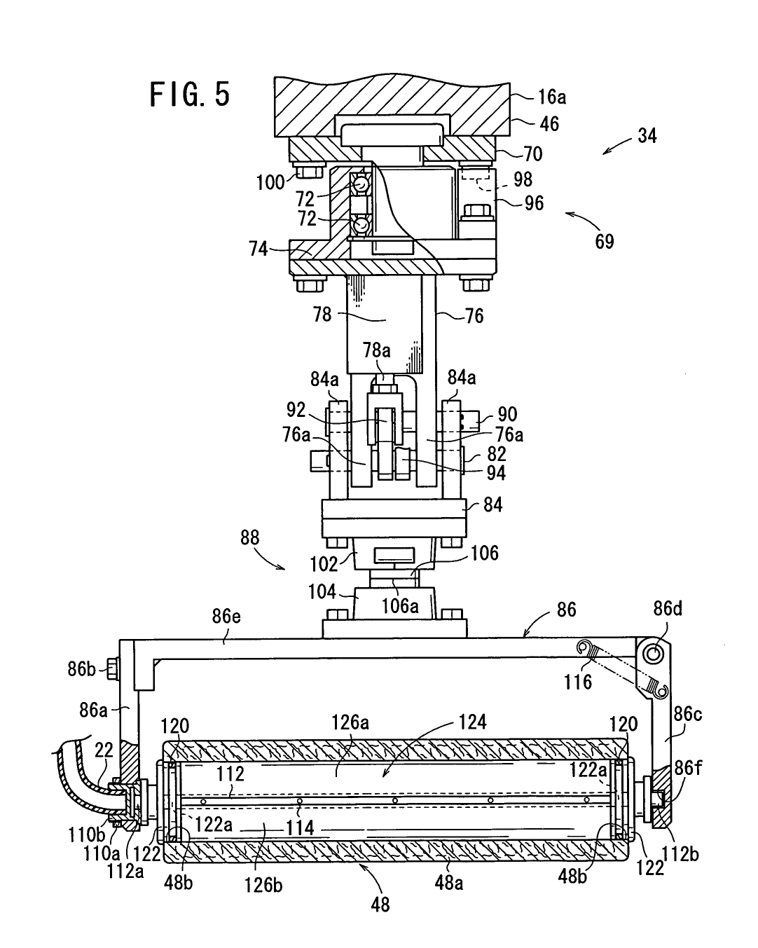

As shown in FIGS. 4 and 5, the holder 86 has a plate-like holder body 86e. A fixed holder member 86a is fixed to an end of the holder body 86e by a bolt 86b, and a movable holder member 86c is pivotally mounted on the other end of the holder body 86e by a shaft 86d. A joint 110b is fixed to the fixed holder member 86a by a nut 110a. The joint 110b has an opening defined in one end thereof, and the coating material pipe 22 is connected to the opening in the joint 110b.

The joint 110b also has an opening defined in the other end thereof, and a hollow pipe 112 has a first end 112a connected to that opening in the joint 110b. The pipe 112 supplies the protective layer forming material from the coating material pipe 22 into the roller 48, which is rotatably supported on the pipe 112. The first end 112a has a plurality of, e.g., two, conical grooves (not shown) defined therein. Embedded bolts (not shown) extending from the joint 110b engage in the conical grooves, firmly securing the pipe 112 to the joint 110b. The pipe 112 has a second end 112b which is closed.

The pipe 112 has a plurality of holes 114 defined therein for delivering the supplied protective layer forming material to the roller 48. The holes 114 may be in the shape of nozzles. The pipe 112 is preferably made of stainless steel, or more preferably made of an SUS304 material (steel classified as austenite steel: Japan Industrial Standards), for example.

The movable holder member 86c has a circular groove 86f defined in a distal end portion thereof. The movable holder member 86c is angularly movable under the bias of a spring 116. The second end 112b of the pipe 112 engages in the circular groove 86f under the resiliency of the spring 116. The pipe 112 is therefore reliably held in place.

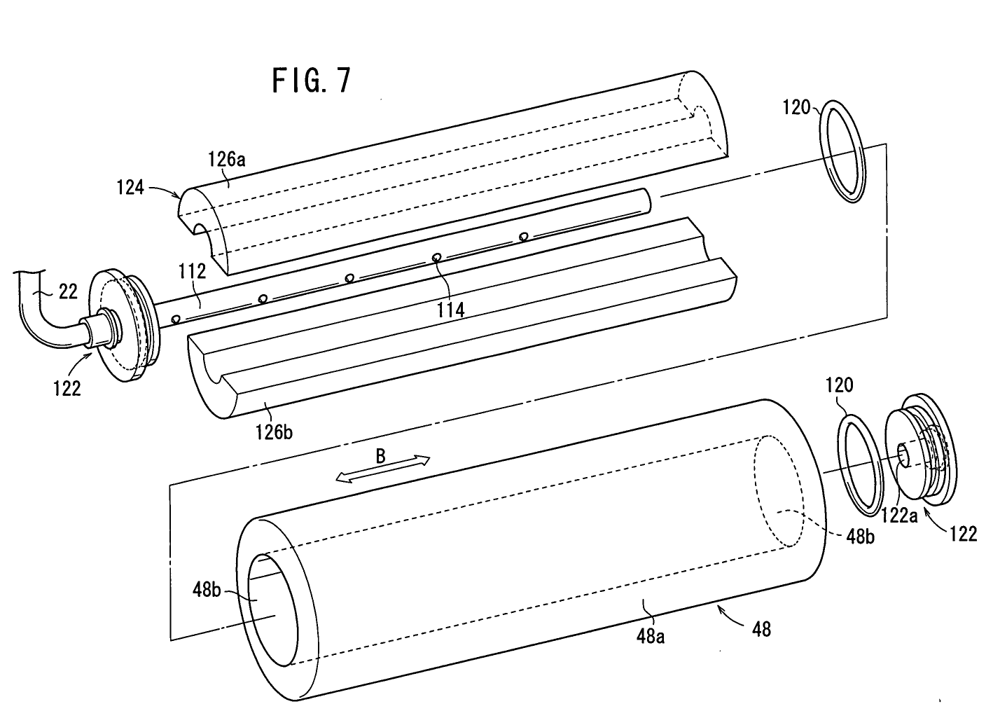

As shown in FIGS. 5 and 7, the roller 48 has an outer circumferential portion serving as a hollow coating member (protective layer forming material absorbing and holding member) 48a made of a material (sponge, bristles, or the like) capable of absorbing and holding the protective layer forming material. The hollow coating member 48a is brought into contact with the surface of the vehicle 14 to apply the protective layer forming material thereto. The roller 48 also has end caps 122 mounted in respective openings 48b in the opposite ends of the coating member 48a in a liquid-tight manner with O-rings 120 interposed therebetween.

The end caps 122 have central holes 122a defined therein. The pipe 112 is directly inserted through the holes 122a, so that the end caps 122 and the coating member 48a are rotatably supported on the pipe 112. The fit of the pipe 112 in the holes 122a is adjusted such that the protective layer forming material can be held in the coating member 48a.

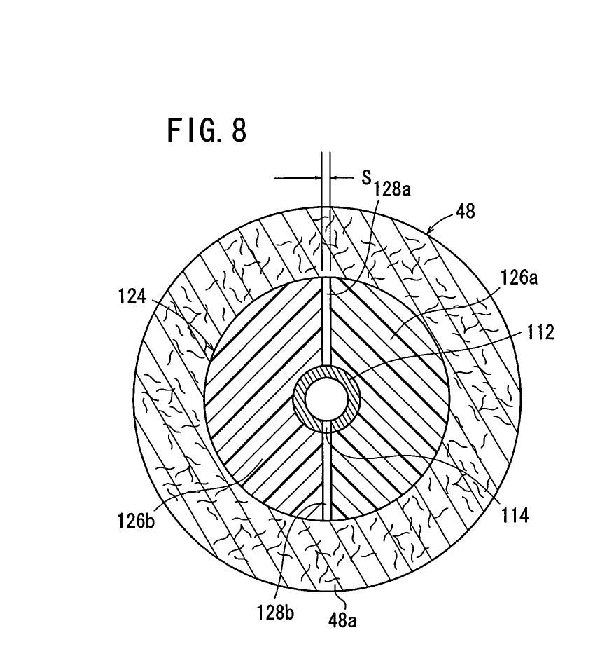

As shown in FIGS. 7 and 8, a substantially hollow cylindrical collar 124 is interposed between the pipe 112 and the coating member 48a. The collar 124 is preferably made of a material which is lightweight and does not absorb the protective layer forming material. For example, the collar 124 is made of plastics. The collar 124 comprises a plurality of, e.g., two, radially separable split members 126a, 126b, with slit-like grooves (conductive holes) 128a, 128b defined between the split members 126a, 126b and extending axially of the roller 48 in the direction indicated by the arrow B in FIG. 7. The grooves 128a, 128b provide a predetermined gap S (see FIG. 8). The split members 126a, 126b may have a plurality of holes extending radially and having openings in the outer circumferential surfaces thereof.

Since the roller 48 and the holder 86 are constructed as described above, the roller 48 can easily be installed and removed, and hence can be handled with ease. Therefore, even if a maintenance process needs to be performed frequently to clean, wash, or replace the roller 48, the maintenance process can efficiently be carried out.

With the roller 48 being constructed as described above, the protective layer forming material delivered through the pipe 112 is absorbed in and held by the coating member 48a, and is reliably applied to the surface of the vehicle 14 by the coating member 48a.

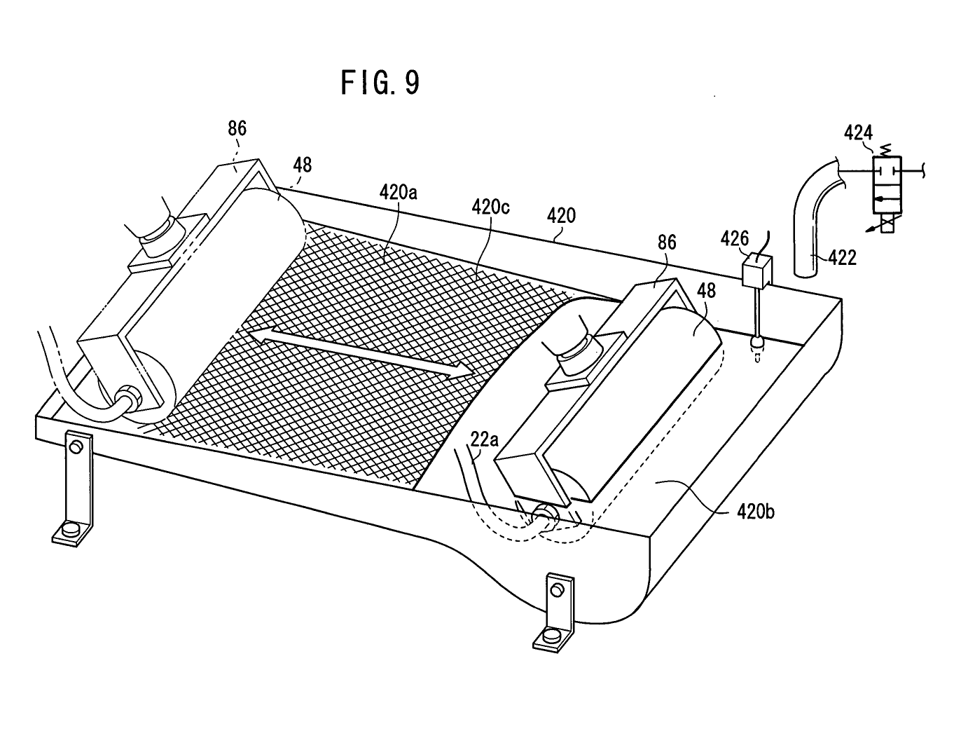

As shown in FIG. 9, the container 420 is of a flat shape and has a width slightly greater than the roller 48 and the holder 86 which holds the roller 48. The container 420 has a gradually slanted surface (planar surface) 420a and a reservoir 420b smoothly joined to a lower portion of the slanted surface 420a. The reservoir 420b has a depth which is about the same as the diameter of the roller 48. The slanted surface 420a has small mesh-like convexities 420c entirely thereon. The slanted surface 420a has a length greater than the diameter of the outer circumference of the roller 48, so that the roller 48 can be rotated through at least 360° when rolling on the slanted surface 420a.

The reservoir 420b is supplied with the protective layer forming material from an upper support port 422, and holds the supplied protective layer forming material. The support port 422 is connected to a solenoid-operated valve 424, which is controlled by the control console 18 to supply the protective layer forming material to the reservoir 420b. The reservoir 420b has a liquid level meter 426 for detecting when the liquid level of the protective layer forming material in the reservoir 420b falls, and operating the solenoid-operated valve 424 to automatically supply the protective layer forming material.

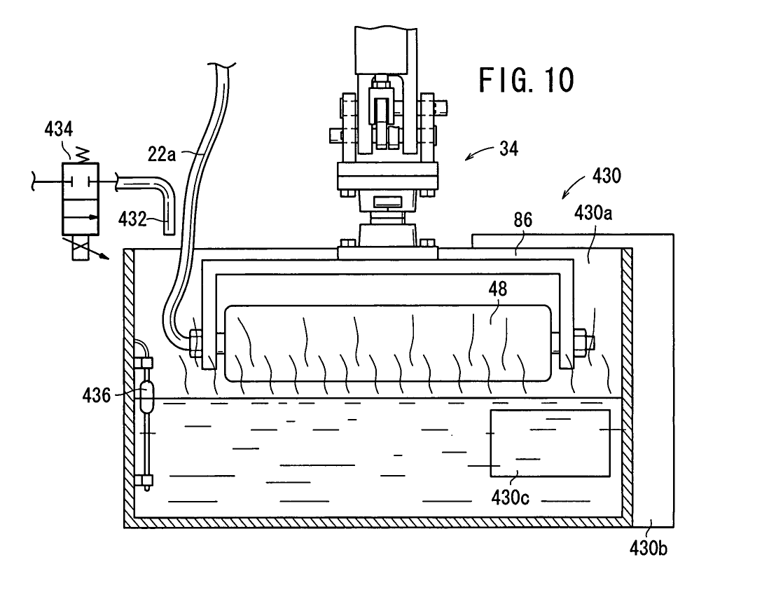

As shown in FIG. 10, the moisture box 430 has a water storage box (water reservoir) 430a which is open upwardly, and an ultrasonic actuator circuit 430b disposed adjacent to the water storage box 430a. The water storage box 430a has a width slightly greater than the roller 48 and the holder 86 which holds the roller 48, and a height that is at least twice the holder 86. The water storage box 430a has on an inner surface thereof an ultrasonic vibrator (vapor generator) 430c which is vibratable at a high frequency by the ultrasonic actuator circuit 430b. When the ultrasonic vibrator 430c is vibrated, the water stored in the water storage box 430a is evaporated (or atomized) to keep the interior of the water storage box 430a damp. With this arrangement, after the ultrasonic vibrator 430c is vibrated, the water can be evaporated highly quickly. The vibrating frequency of the ultrasonic vibrator 430c is set such that the particles of the water vapor are of an appropriate size.

The water storage box 430a is supplied with water from an upper supply port 432 and holds the supplied water. The support port 432 is connected to a solenoid-operated valve 434, which is controlled by the control console 18 to supply the protective layer forming material to the water storage box 430a. The water storage box 430a has a liquid level meter 436 for detecting when the liquid level of the protective layer forming material in the water storage box 430a falls, and operating the solenoid-operated valve 434 to automatically supply water. Usually, the solenoid-operated valve 434 supplies water so that the level of water is substantially half the height of the water storage box 430a.

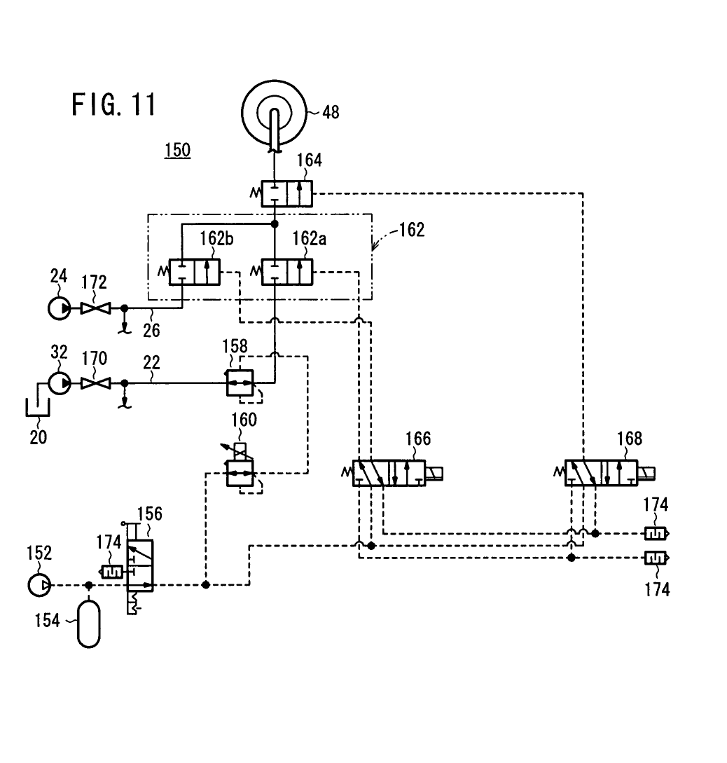

As shown in FIG. 11, a composite hydraulic and pneumatic circuit (supply mechanism) 150 for supplying the protective layer forming material and water to the roller 48, the container 420, and the moisture box 430 has a compressor 152, an air tank 154 connected to the outlet port of the compressor 152, a manually operated pneumatic charge valve 156 for selectively supplying and blocking a pneumatic pressure, a regulator control valve 160 for reducing a secondary pressure with an electric signal supplied from the control console 18, and a regulator (pressure regulating valve) 158 which is pilot-controlled by the secondary pressure of the regulator control valve 160 for reducing the pressure in the coating material pipe 22. The composite circuit 150 also has an MCV (Material Control Valve) 162 to which the secondary pipe of the regulator 158 and the water pipe 26 are connected. A trigger valve 164 is disposed between the secondary side of the MCV 162 and the roller 48. The MCV 162 has switching valves 162a, 162b for selectively bringing the coating material pipe 22 and the water pipe 26 into and out of communication with each other. The switching valves 162a, 162b have respective secondary sides communicating with each other. Broken lines in FIG. 11 represent pneumatic pipes.

The MCV 162 and the regulator control valve 160 are not limited to pneumatic pilot-operated valves, but may be valves that are actuatable by electric solenoids or the like.

The composite circuit 150 further includes an MCV switching solenoid-operated valve 166 for selectively supplying the pneumatic pressure from the pneumatic charge valve 156 to pilot-operate the switching valves 162a, 162b, and a trigger switching solenoid-operated valve 168 for pneumatically pilot-operating the trigger valve 164.

When supplied with an electric signal from the control console 18, the MCV switching solenoid-operated valve 166 opens either one of the switching valves 162a, 162b and closes the other of the switching valves 162a, 162b, selectively supplying water and the protective layer forming material to the trigger valve 164. In response to an electric signal from the control console 18, the trigger switching solenoid-operated valve 168 selectively opens and closes the trigger valve 164 to supply water or the protective layer forming material to the roller 48.

Manual shut-off valves 170, 172 are connected respectively to the coating material pipe 22 and the water pipe 26. The shut-off valves 170, 172 are normally open. Silencers 174 are connected to respective air outlet ports of the composite circuit 150 for reducing discharged air noise. The compressor 152, the pump 32, and the water source 24 are combined with respective relief valves (not shown) for preventing an undue pressure buildup.

The solenoid-operated valve 424 is connected to the coating material pipe 22, so that the protective layer forming material can be supplied to the container 420 through the solenoid-operated valve 424. The solenoid-operated valve 434 is connected to the water pipe 26, so that water can be supplied to the moisture box 430 through the solenoid-operated valve 434.

The compressor 152, the air tank 154, the water source 24, and the pump 32 of the composite circuit 150 are shared by the robots 16a, 16b, 16c. Other devices are individually associated with the robots 16a, 16b, 16c.

As shown in FIG. 12, the roller setting menu displayed on the monitor screen 18b has a washing time table 440 and a material filling time table 442. The washing time table 440 is a table for setting times (hereinafter referred to as washing setting times) for performing a washing action with respect to the respective robots 16a, 16b, 16c. The material filling time table 442 is a table for setting times (hereinafter referred to as material filling setting times) for performing a first action (an action to cause the protective layer forming material to seep into the roller 48 using the container 420) with respect to the respective robots 16a, 16b, 16c. Each of the washing time table 440 and the material filling time table 442 has a row of “SETTING VALUES” and a row of “ELAPSED TIMES”. The worker operates the input device 18a to enter washing setting times and material filling setting times into the washing time table 440 and the material filling time table 442 with respect to the respective robots 16a, 16b, 16c. The washing setting times and the material filling setting times are held in a predetermined recorder.

The row of “ELAPSED TIMES” in the washing time table 440 and the material filling time table 442 displays elapsed times of operation of the respective robots 16a, 16b, 16c. The displayed elapsed times are reset to “0.0” each time the washing action and the first action are performed. Immediately after the displayed elapsed times are reset, the measurement of time is automatically resumed, and elapsed times are displayed.

The monitor screen 18b also has a start button 444, a stop button 446, and a standby attitude button 448 which are pointed out by a given pointing device. The start button 444 and the stop button 446 are buttons for starting and stopping operation of the robots 16a, 16b, 16c. The standby attitude button 448 is a button for bringing the robots 16a, 16b, 16c into a given standby attitude out of interference with the vehicle 14 and other objects. The start button 444, the stop button 446, and the standby attitude button 448 can individually instruct the robots 16a, 16b, 16c to operate through certain actions.

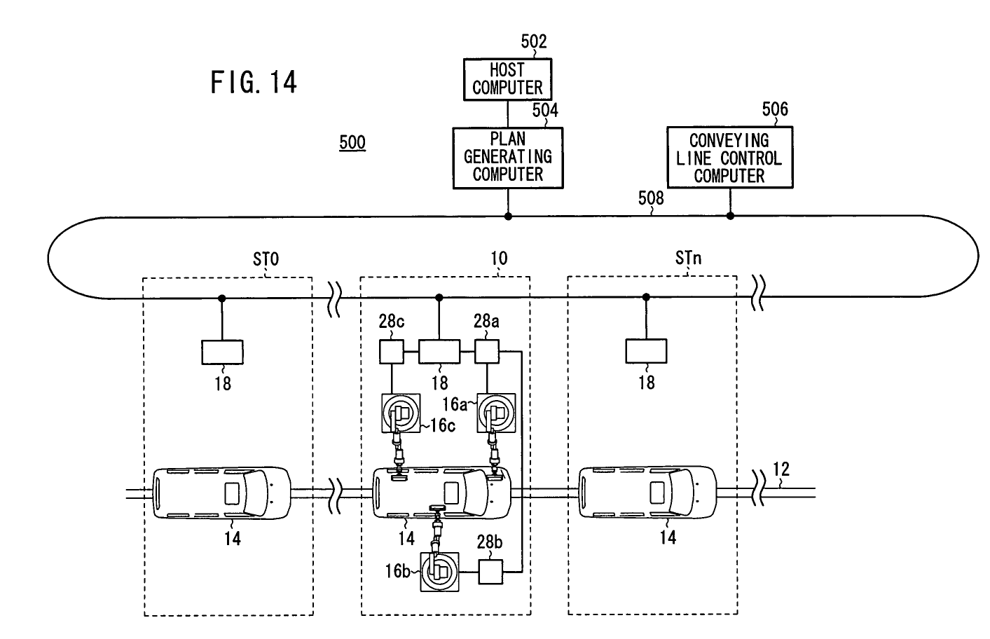

As shown in FIG. 14, the coating system 10 for applying a protective layer forming material is regarded as a system including one station in a production system 500 in a factory for producing vehicles 14. The production system 500 has a host computer 502 for holding a monthly order file containing information as to a monthly production plan, a plan generating computer 504 for receiving the monthly production plan from the host computer 502 and generating a daily executed manufacturing plan file, and a conveying line control computer for generating production management information 618 (see FIGS. 15 through 17), material charging data, idle device instruction information, and combining instruction information based on the daily executed manufacturing plan file. The production system 500 may be a system disclosed in Japanese Laid-Open Patent Publication No. 9-141531, for example.

The coating system 10 for applying a protective layer forming material, the plan generating computer 504, the conveying line control computer 506, and stations ST0, STn, etc. are connected to a computer network 508, and can communicate with each other through the computer network 508. The conveying line 12 used in the production system 500 is not limited to a single line shown in FIG. 14, but may be a plurality of lines, and may have branches and junctions.

As shown in FIGS. 15 through 17, the production management information 618 generated by the conveying line control computer 506 comprises table data representing recorded information as to each of vehicles 14 and carriages 15 based on the sequence of operation of the conveying line 12. The information as to each of vehicles 14 includes information about a vehicle identification number, a vehicle type, a paint color, and whether the vehicle is a back-ordered vehicle or not. If a carriage 15 is idle, then “IDLE CARRIAGE” is recorded in the column of vehicle identification numbers. As described above, a back-ordered vehicle is a vehicle customized to specifications requested by a user, and does not need to be coated with the protective layer forming material as the vehicle is handed over to the user immediately after it is manufactured.

The production management information 618 is supplied to each of the stations at a given time, either automatically or in response to a transmission request from the station. Each of the stations is capable of recognizing, in advance, information as to a vehicle 14 and a carriage 15 to be conveyed subsequently, based on the received production management information 618.

For example, when the coating system 10 for applying a protective layer forming material, which serves as one station, receives the production management information 618 shown in FIG. 15, the control console 18 of the coating system 10 recognizes that the vehicle 14 which has been conveyed at the time has a vehicle identification number “17385”, and the vehicle type and paint color of the vehicle 14 are “ACD-1” and “rd”, respectively. In addition, the back-order column for the vehicle 14 has “-” recorded therein which indicates that the vehicle 14 is not a back-ordered vehicle. Therefore, the coating system 10 can recognize that the vehicle 14 needs to be coated with the protective layer forming material. If “O” is recorded in the back-order column for the vehicle 14, then it indicates that the vehicle 14 is a back-ordered vehicle, and the coating system 10 can recognize that the vehicle 14 does not need to be coated with the protective layer forming material.

When an idle carriage 15 with no vehicle 14 placed thereon is conveyed in, then “IDLE CARRIAGE” (not shown) is recorded in the column of vehicle identification numbers, and “Δ” (not shown) is recorded in the back-order column, indicating that there is no need to apply the protective layer forming material.

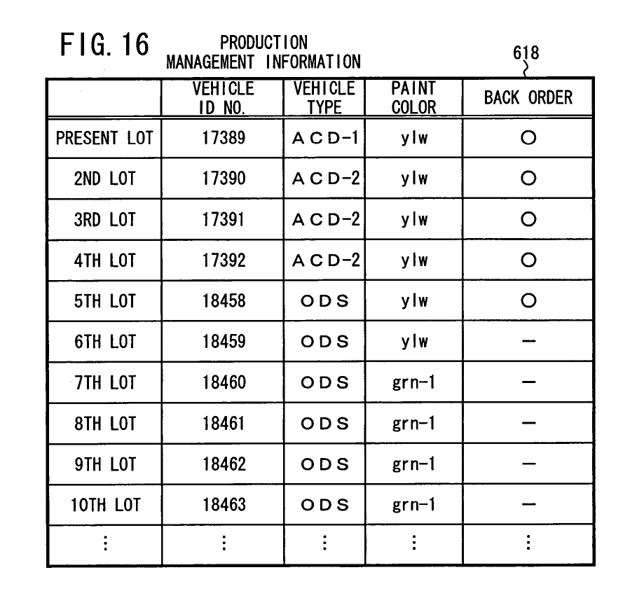

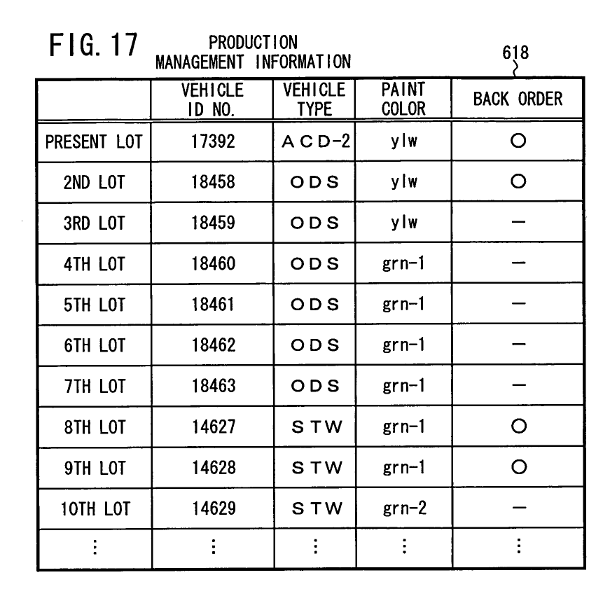

After the coating system 10 has received the production management information 618 shown in FIG. 15, when four vehicles 14, for example, have been conveyed along, the coating system 10 receives the production management information 618 shown in FIG. 16. Thereafter, when three vehicles 14, for example, have been conveyed along, the coating system 10 receives the production management information 618 shown in FIG. 17.

A process of training the robots 16a, 16b, 16c to apply the protective layer forming material before the vehicle 14 is coated with the protective layer forming material is will be described below.

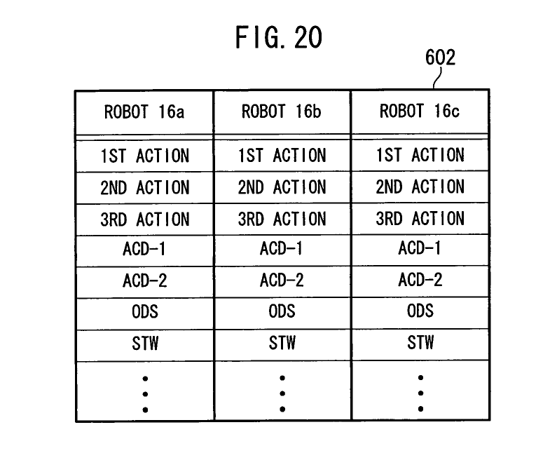

The robots 16a, 16b, 16c are assigned to an engine hood 14a (see FIG. 1), a front roof area 14b, and a rear roof area 14c, respectively, and are trained to apply the protective layer forming material to the assigned areas. Teaching data by which the robots 16a, 16b, 16c are trained are recorded in a data recorder 602 (see FIG. 20) of the control console 18, and held therein. If the vehicle 14 is a sedan, then the robot 16c is assigned to a trunk area.

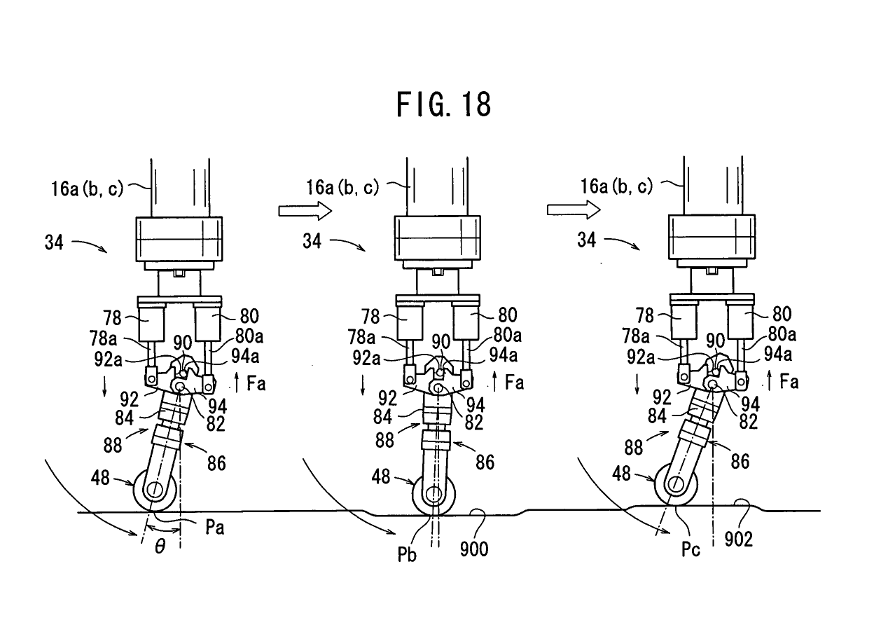

Specifically, as shown in FIG. 18, for training the robot 16a having the roller mechanism 34, the third arm 46 of the robot 16a is spaced from the surface of the vehicle 14 by a suitable distance, or specifically the swing member 84 is trained to be inclined through a predetermined angle 0 at a flat location Pa, and the third arm 46 is moved parallel to the surface of the vehicle 14 from the flat location Pa. At a location Pb in a shallow recess 900 in a surface continuous to the flat location Pa, the third arm 46 may be moved parallel to the surface at the flat location Pa. Furthermore, at a location Pc on a low land 902 on a surface continuous to the flat location Pa, the third arm 46 may be moved parallel to the surface at the flat location Pa. In this manner, the recess 900 and the land 902 may be ignored, and the inclined angle of the swing member 84 may be somewhat varied. It is easy to train the robot 16a by ignoring the shallow recess 900 and the relatively low land 902.

For applying the protective layer forming material to the vehicle 14 while moving the robot 16a to the right as shown in FIG. 18, air is supplied to the right pneumatic cylinder 80 to generate a relatively weak force Fa in a direction to contact the rod 80a, and air is supplied to the left pneumatic cylinder 78 to extend the rod 78a. The pressing surface 94a of the right pin presser 94 presses a right side surface of the pin 90 under a relatively weak force, and the pressing surface 92a of the left pin presser 92 is spaced from the pin 90. Accordingly, the swing member 84 and the roller 48 are subjected to a force applied counterclockwise about the swing shaft 82, and the roller 48 is pressed against the surface of the vehicle 14 under a suitable pressing force.

The force Fa may be adjusted depending on the location to which the roller 48 is applied and the method by which the roller 48 is moved. The force Fa can easily be adjusted by operating a pressing force adjusting functional unit corresponding to the regulator 176 with the control console 18 or operating a given dial or the like.

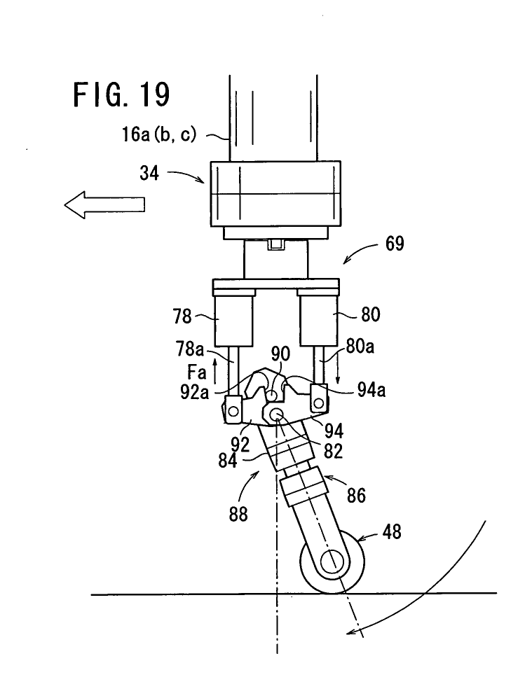

As shown in FIG. 19, for applying the protective layer forming material to the vehicle 14 while moving the robot 16a to the left as shown in FIG. 19, air is supplied to the left pneumatic cylinder 78 to generate a relatively weak force Fa in a direction to contact the rod 78a, and air is supplied to the right pneumatic cylinder 80 to extend the rod 80a. The pressing surface 92a of the left pin presser 92 presses a left side surface of the pin 90 under a relatively weak force, and the pressing surface 94a of the right pin presser 94 is spaced from the pin 90. Accordingly, the swing member 84 and the roller 48 are subjected to a force applied clockwise about the swing shaft 82, and the roller 48 is pressed against the surface of the vehicle 14 under a suitable pressing force.

When the direction of flow and the pressure of air supplied to the pneumatic cylinders 78, 80 are thus controlled depending on the direction in which the robot 16a travels, the roller 48 can be pressed against the surface of the vehicle 14 under a suitable pressing force. Specifically, the weight of the roller 48 is effectively utilized as a pressing force, and a pressing force shortage that cannot be provided by the weight of the roller 48 is compensated for by the pneumatic cylinder 78 or the pneumatic cylinder 80.

Therefore, the roller 48 is prevented from rotating idly or from jumping when passing over the recess 900 or the land 902. The protective layer forming material tends to seep out of the roller 48. At this time, since the roller 48 is swingable about the swing shaft 82, the roller 48 is reliably held in abutment against the recess 900 and the land 902 for applying the protective layer forming material. Specifically, when the roller 48 passes over the recess 900 or the land 902, the rod 78a or 80a is extended or contracted depending on the depth of the recess 900 or the height of the land 902. Because the pneumatic cylinders 78, 80 employ highly compressible air as an actuating fluid, the pneumatic cylinders 78, 80 can operate flexibly and can easily absorb external force variations.

Since the pin presser 92 coupled to the rod 78a of the pneumatic cylinder 78 and the pin presser 94 coupled to the rod 80a of the pneumatic cylinder 80 apply pressing forces to the swing member 84 in respective opposite directions, the swing member 84 can operate appropriately even if it is inclined clockwise or counterclockwise. Therefore, the roller 48 can apply the protective layer forming material while it is moving to the right or the left.

The robot is trained to finish the process of applying the protective layer forming material within a tact time that is preset for each vehicle 14 on the conveying line 12.

Each of the robots 16a, 16b, 16c is trained to perform a first action, a second action, and a third action to be described below.

The first action is an action to immerse the roller 48 in the protective layer forming material in the reservoir 420b of the container 420 (see FIG. 9), and thereafter roll the roller 48 reciprocally in a plurality of strokes (e.g., 10 strokes) on the slanted surface 420a. Since the slanted surface 420a has a lower portion smoothly joined to the reservoir 420b, the first action is a simple smooth action which can easily be taught. The first action is an action to prepare the roller 48 into a state suitable for coating, and is also referred to as a preparing action.

The second action is an action to insert the roller 48 into the water storage box 430a of the moisture box 430 (see FIG. 10). According to the second action, the robot is trained to keep the roller 48 out of contact with the water in the water storage box 430a.

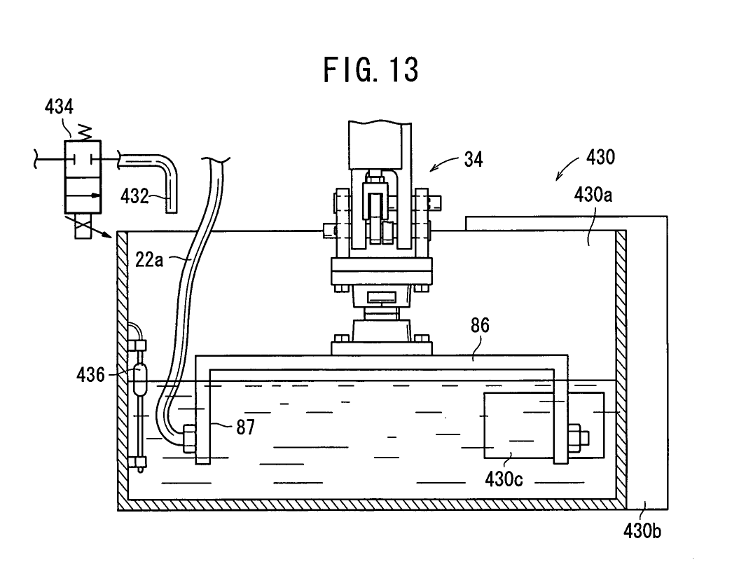

The third action is an action to insert the holder 86 into the water storage box 430a of the moisture box 430 (see FIG. 13). According to the third action, the robot is trained to dip a tube connector (protective layer forming material support port) 87 (see FIG. 13) of the holder 86 into the water in the water storage box 430a. At this time, the roller 48 is detached from the holder 86.

Teaching data by which the robots 16a, 16b, 16c are thus trained are recorded in the data recorder 602, as shown in FIG. 20. As can be seen from FIG. 20, the teaching data of the robots 16a, 16b, 16c are classified as teaching data for the first action, the second action, and the third action, and teaching data for the types of vehicles 14. In FIG. 20, “ACD-1”, “ADC-2”, “ODS”, and “STW” represent teaching data corresponding to vehicle types, and correspond to the symbols in the column of “VEHICLE TYPE” in FIGS. 15 through 17. “ACD-1” represents standard specifications for the vehicle type called “ACD”, and “ACD-2” represents specifications with a sunroof opening 14d (see FIG. 1) for the vehicle type called “ACD”. Specifications may distinguishably indicate whether an air intake, a protruding part (also called a bulge), a rear spoiler, a roof antenna, etc. are present or not, other than whether the sunroof opening 14d is present or not.

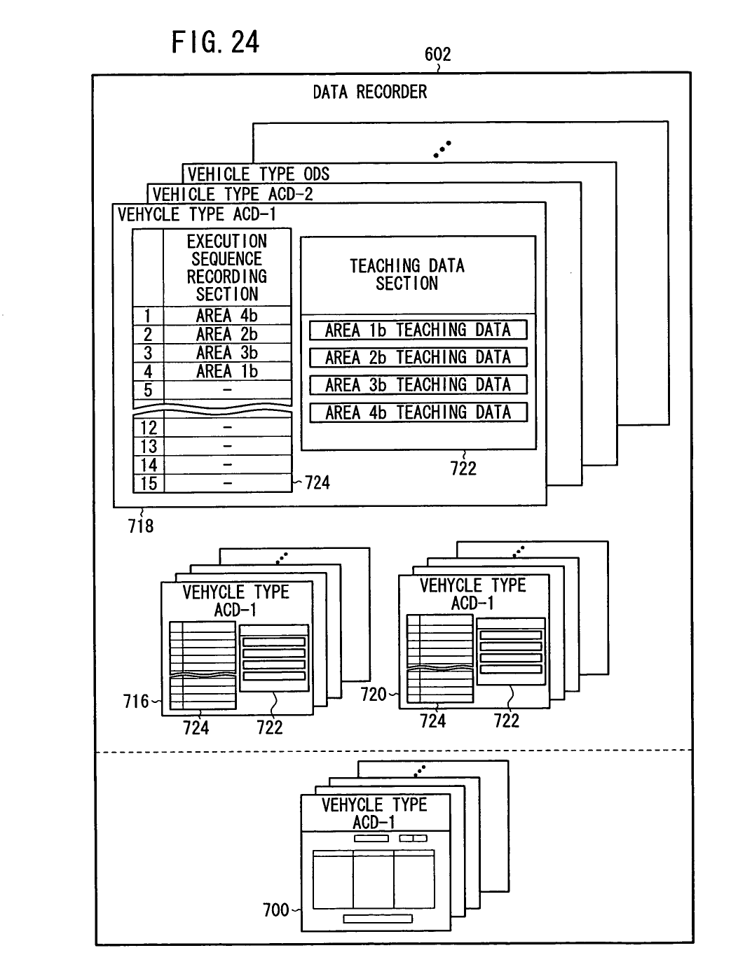

The data indicated as “ACD-1”, “ADC-2”, “ODS”, and “STW” in FIG. 20 corresponding to teaching data 716, 718, 720 shown in FIG. 24.

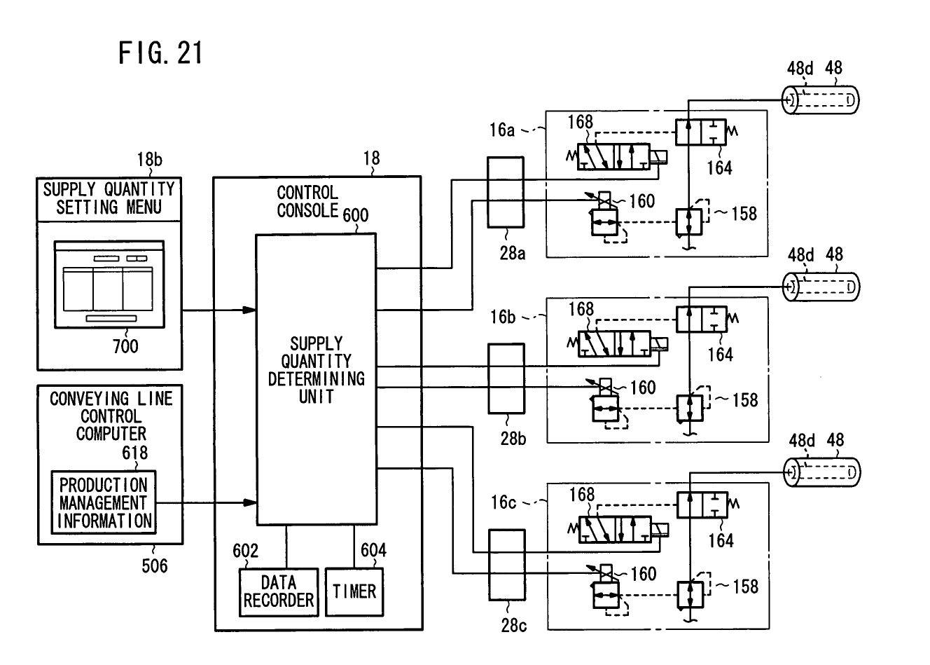

Now, an arrangement of the control console 18, the production management information 618, and the supply quantity setting menu displayed on the monitor screen 18b will be described below with reference to FIGS. 21 through 25.

The control console 18 has a supply quantity determining unit 600, a data recorder 602 and a timer 604 which are connected to the supply quantity determining unit 600. The supply quantity determining unit 600 can recognize whether the vehicle 14 is being conveyed or at rest based on data supplied from the conveying line control computer 506.

The supply quantity determining unit 600 has a function to control the trigger valve 164 through the trigger switching solenoid-operated valve 168 of each of the robots 16a, 16b, 16c, and can adjust the time to supply the protective layer forming material in coaction with the timer 604. The supply quantity determining unit 600 also has a function to control the regulator 158 through the regulator control valve 160, and can regulate the pressure to supply the protective layer forming material.

These functions of the control console 18 are performed by a program which is run on a computer (not shown). The control console 18 further has functions to control the robots 16a, 16b, 16c, the MCV switching solenoid-operated valve 166, etc. in addition to the functions described above.

As shown in FIG. 22, the supply quantity setting menu displayed on the monitor screen 18b has a supply quantity setting table 700 for setting quantities of the protective layer forming material to be supplied to the robots 16a, 16b, 16c. The supply quantity setting table 700 is provided for each of types of vehicles 14, and is saved in the table recorder 602 (see FIG. 24).

The supply quantity setting menu also has a vehicle type input box 702 for entering the type of the vehicle 14, a supply quantity reading button 704 for reading the saved supply quantity setting table 700 from the data recorder 602 (see FIG. 24), a supply quantity saving button 706 for saving a set supply quantity setting table 700 in the data recorder 602, and an error message box 708 for displaying an error with respect to setting information.

The supply quantity setting table 700 comprises setting columns 700a, 700b, 700c corresponding respectively to the robot 16a, the robot 16b, and the robot 16c.

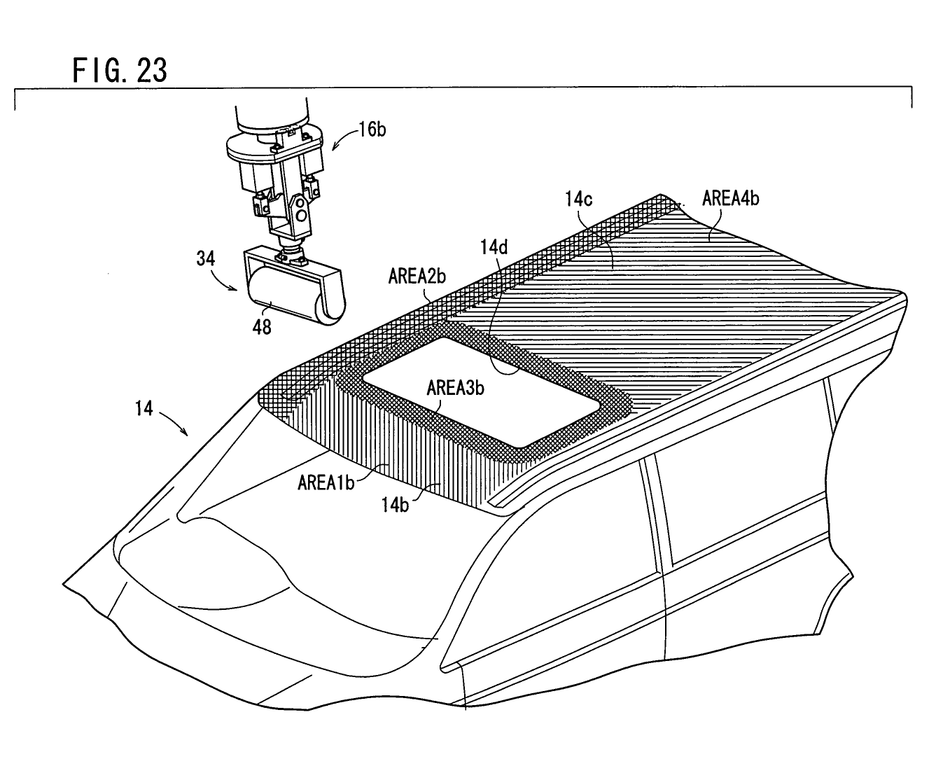

The setting column 700b has setting rows corresponding respectively to 15 coating areas AREA1b through AREA15b including four coating areas AREA1b, AREA2b, AREA3b, and AREA4b (see FIG. 23) on the coating surface wherein the robot 16b applies the protective layer forming material to the vehicle 14.

As shown in FIG. 23, the coating area AREA1b is set mainly as the front roof area 14b, and the coating area AREA2b is set mainly as an end roof area. The coating area AREA3b is set mainly as an area around the sunroof opening 14d, and the coating area AREA4b is set mainly as the rear roof area 14c.

Referring back to FIG. 22, the setting columns 700a, 700c have setting rows corresponding to 15 coating areas AREA1a through AREA15a and 15 coating areas AREA1c through AREA15c.

Each of the setting rows of the coating areas AREA1a through AREA15a, AREA1b through AREA15b, and AREA1c through AREA15c has a pressure column 710, a time column 712, and a supply quantity column 714. In the example shown in FIG. 22, the coating areas AREA5a through AREA15a, AREA5b through AREA15b, and AREA5c through AREA15c are not used, and are handled as reserved areas.

The pressure column 710 is used to enter pressures to supply the protective layer forming material when the robot 16b coats corresponding coating areas. The time column 712 is used to enter times to supply the protective layer forming material when the robot 16b coats corresponding coating areas.

The supply quantity column 714 automatically displays estimated quantities by which the protective layer forming material will be supplied, based on the pressures and the times that have been set.

When a pressure value set in the pressure column 710 is greater than an allowable pressure or when a time set in the time column 712 is greater than an allowable time for the corresponding coating location, the error message box 708 displays an error message to prompt the worker to correct the setting.

Since the surface of the vehicle 14 to be coated with the protective layer forming material is thus divided into a plurality of coating areas and settings can be entered for the coating areas into the supply quantity setting table 700, it is easy to set pressures and times to supply the protective layer forming material.

As shown in FIG. 24, the data recorder 602 records therein supply quantity setting tables 700, teaching data 716 of the robot 16a, teaching data 718 of the robot 16b, and teaching data 720 of the robot 16c with respect to respective types of vehicles 14. Each of the teaching data 716, 718, 720 includes a teaching data section 722 and an execution sequence recording section 724.

The data recorder 602 also records therein teaching data for the first through third actions (see FIG. 11).

The teaching data section 722 records therein teaching data for the respective coating areas of the surface of the vehicle 14 to be coated with the protective layer forming material. In the example shown in FIG. 24, with respect to operations to be performed on the vehicle type “ACD-1”, four of the teaching data 718 of the robot 16b, which correspond to AREA1b, AREA2b, AREA3b, AREA4b (see FIG. 23), are recorded. The teaching data section 722 can record therein teaching data corresponding to up to 15 coating areas AREA1b through AREA15b.

The execution sequence recording section 724 records therein an execution sequence of teaching data that are recorded in the teaching data section 722. In the example shown in FIG. 24, with respect to operations to be performed on the vehicle type “ACD-1”, a sequence of the four teaching data 718 of the robot 16b which are to be executed in the order of AREA4b, AREA2b, AREA3b, AREA1b is recorded.

The robot 16b is trained to perform operations on the respective coating areas AREA1b, AREA2b, AREA3b, AREA4b, as shown in FIG. 23, and the operations are recorded as the teaching data 718 in the data recorder 602, as shown in FIG. 24.

Prior to applying the protective layer forming material, the pressure and time to supply the protective layer forming material for each of the coating areas are set using the supply quantity setting menu displayed on the monitor screen 18b (see FIG. 22), and supply quantities displayed in the supply quantity column 714 are confirmed.

After the above preparatory process, the conveying line 12 is operated to move the vehicle 14 under the control of the conveying line control computer 506. At this time, the supply quantity determining unit 600 receives production management information 618 and determines the type of a next vehicle 14 to be conveyed in. Based on the determined vehicle type, the supply quantity determining unit 600 reads the teaching data 716, 718, 720 of the robots 16a, 16b, 16c from the data recorder 602, and supplies the teaching data 716, 718, 720 to the robot controllers 28a, 28b, 28c.

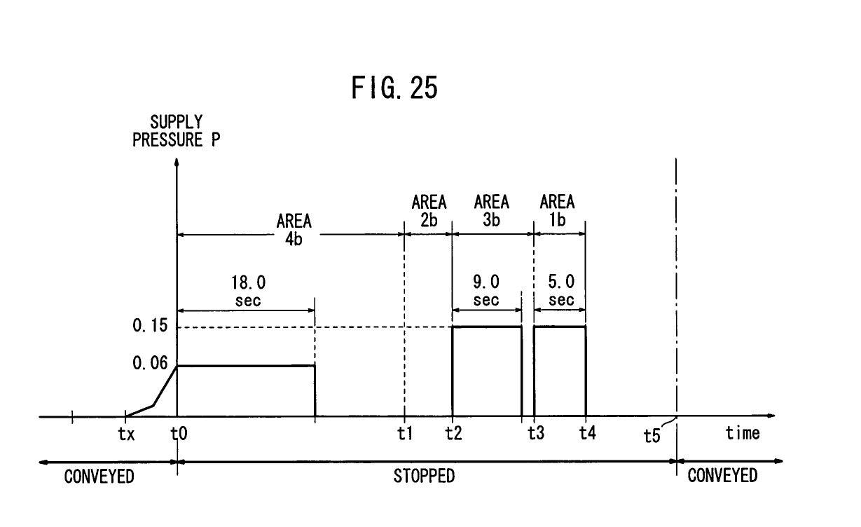

Based on the vehicle type, the supply quantity determining unit 600 (see FIG. 21) of the control console 18 also reads the supply quantity setting table 700 from the data recorder 602. Based on the received information supplied from the conveying line control computer 506, the supply quantity determining unit 600 can recognize whether the vehicle 14 is being conveyed or at rest, and can also recognize a time t0 (see FIG. 25) when the conveying of the vehicle 14 is finished and the conveying line 12 is inactivated.

The supply quantity determining unit 600 can thus recognize in advance the type of the vehicle 14 that is conveyed in based on the production management information 618. By reading the teaching data 716, 718, 720 and the supply quantity setting table 700 from the data recorder 602 depending on the type of the vehicle 14, the supply quantity determining unit 600 can quickly start coating the vehicle 14 when the vehicle 14 is conveyed in.

As shown in FIG. 25, the supply quantity determining unit 600 starts supplying the protective layer forming material from the time t0. At this time, pressures and times to supply the protective layer forming material are individually set for the coating areas AREA1b through AREA4b based on the supply quantity setting table 700 (see FIG. 22).

Specifically, the coating areas are coated with the protective layer forming material in the order of the coating areas AREA4b (times t0 to t1), AREA2b (times t1 to t2), AREA3b (times t2 to t3), AREA1b (times t3 to t4) as set forth in the execution sequence recording section 724 (see FIG. 24). For coating the coating area AREA4b, the protective layer forming material is supplied to the roller 48 under the supply pressure of 0.06 [MPa] for first 18.0 [sec.]. For coating the coating area AREA3b, the protective layer forming material is supplied to the roller 48 under the supply pressure of 0.15 [MPa] for first 9.0 [sec.]. For coating the coating area AREA1b, the protective layer forming material is supplied to the roller 48 under the supply pressure of 0.15 [MPa] for 5.0 [sec.]. The period between the times t3 to t4 in which to coat AREA1b is 5.0 [sec.], and the protective layer forming material is supplied at all times during this period. The supply pressure is regulated by operating the regulator 158 as described above.

As indicated in the supply quantity setting table 700 (see FIG. 24), the data entered in the pressure column 710 and the time column 712 for the coating area AREA2b are “0.00” and “0.0”, respectively. Therefore, the coating process is performed on the coating area AREA2b while no protective layer forming material is being supplied. In this case, the coating area AREA2b is coated with the protective layer forming material which has previously been absorbed and remains in the roller 48. The pressures and times to supply the protective layer forming material may suitably be corrected depending on the ambient temperature and humidity.

In this manner, when the vehicle 14 is coated with the protective layer forming material, the pressure to supply the protective layer forming material is appropriately varied depending on the location to be coated based on the supply quantity setting table 700. Since the coating area AREA2b is an area on the roof end, the protective layer forming material is prevented from sagging by setting the supply quantity thereof to 0. Since the coating area AREA4b is the rear roof area 14c which is wide, the protective layer forming material can continuously be supplied in an appropriate quantity, preventing a coating thickness shortage or thin coating spots, by being supplied under a suitable pressure for a relatively long period of time.

As described above, the collar 124 is disposed in the roller 48 (see FIG. 5), which has a very small space therein for the protective layer forming material to be kept therein. Therefore, the protective layer forming material that is supplied from the holes 114 in the pipe 112 passes through the grooves 128a, 128b (see FIG. 8) and quickly reaches the coating member 48a (see FIG. 5) for being applied to the vehicle 14. Consequently, changes that are caused in the supply pressure by the supply quantity determining unit 600 are quickly reflected in the coating process for performing an appropriate coating process on each of the coating areas.

Regardless of the setting data in the supply quantity setting table 700, the protective layer forming material may be supplied in an appropriate quantity from a time tx (see FIG. 25) slightly earlier than the time t0. The protective layer forming material thus supplied can seep in a suitable quantity into the roller 48 until the time t0, allowing the coating process to be quickly performed.

The example shown in FIG. 25 indicates a pattern according to which the protective layer forming material is supplied to the robot 16b. With respect to the other robots 16a, 16b, the pressures and times to supply the protective layer forming material for each of the coating areas are controlled concurrently to supply the protective layer forming material based on the supply quantity setting table 700.

When a time t5 (see FIG. 5) of the tact time is reached, the vehicle 14 that has been coated with the protective layer forming material by the robots 16a, 16b, 16c is conveyed to a next process by the conveying line 12. The applied protective layer forming material is dried naturally or by an applied flow of air, forming a peelable protective layer which protects the painted area of the vehicle 14.

The robots 16a, 16b, 16c hold the standby attitude out of interference with the vehicle 14, and wait until a next vehicle 14 is conveyed in. At this time, the control console 18 receives the production management information 618 again from the conveying line control computer 506, recognizes the type of the next vehicle 14 to be conveyed in, and prepares a coating process depending on the vehicle type.

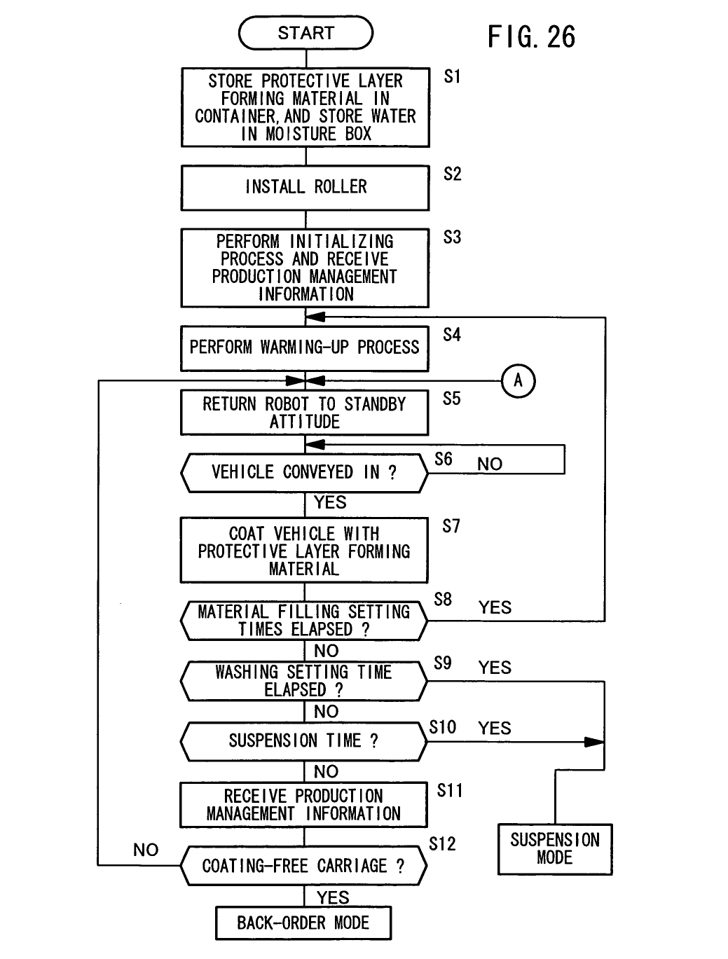

A procedure for coating the vehicle 14 with the protective layer forming material and a procedure for suspending the coating process, after the training of the robots 16a, 16b, 16c and other preparatory processes are finished, will be described below with reference to FIGS. 26 through 28.

In step S1, the container 240 and the water storage box 430a of the moisture box 430 are supplied respectively with the protective layer forming material and water up to predetermined levels. This process is automatically performed by the liquid level meters 426, 436 and the solenoid-operated valves 424, 434.

Then, in step S2, the robots 16a, 16b, 16c are brought into the standby attitude, and the roller 48 is installed on the holder 86. The roller 48 is either an unused one or has been washed to drain off any protective layer forming material therefrom. A process of washing the roller 48 will be described later.

In step S3, a predetermined initial action is carried out. Specifically, the protective layer forming material is heated to a suitable temperature by a given heater, and the compressor 152, the water source 24, and the pump 32 are operated. The robots 16a, 16b, 16c are kept in the standby attitude, and the pneumatic charge valve 156 is opened.

At this time, the production management information 618 is received to confirm the type of a first vehicle 14 which is to be conveyed in.

In step S4, the preparatory action which has been taught in advance is performed. Specifically, the roller 48 is immersed in the protective layer forming material in the reservoir 420b, and thereafter rolled a plurality of times on the slanted surface 420a. At this time, the inner surface of the roller 48 is also supplied with the protective layer forming material from the tube 22a.

It takes some time for the protective layer forming material supplied from the tube 22a to seep out on the surface of the roller 48. However, the preparatory action makes it possible to begin the coating process immediately because the protective layer forming material in the reservoir 420b can seep quickly and sufficiently into the roller 48 evenly. The protective layer forming material in the reservoir 420b that has seeped in the roller 48 makes the material (e.g., bristles) of the roller 48 soft and hence makes it suitable for the coating process.

Inasmuch as the slanted surface 420a has a lower portion smoothly joined to the reservoir 420b, the roller 48 can move smoothly from the reservoir 420b to the slanted surface 420a, making the protective layer forming material less liable to leak or be scattered out. Excessive protective layer forming material that seeps out when the roller 48 rolls flows down the slanted surface 420a into the reservoir 420b for reuse.

Since the slanted surface 420a is longer than the outside diameter of the roller 48, the roller 48 can be rotated through at least 360° for allowing the protective layer forming material to seep uniformly into the full circumferential surface of the roller 48. As the roller 48 is resisted by the mesh-like convexities 420c on the slanted surface 420a, the roller 48 does not roll idly. The surface of the roller 48 is repeatedly compressed and expanded by the convexities 420c, so that the protective layer forming material finds it easy to seep into the roller 48.

After the protective layer forming material has seeped into the roller 48 in the preparatory action, the robots 16a, 16b, 16c are returned to the standby attitude (step S5).

In step S6, a vehicle 14 which has been painted is conveyed by the conveying line 12 and stopped in the vicinity of the robots 16a, 16b. 16c. The control console 18 confirms that the vehicle 14 or the carriage 15 has been conveyed in with a signal supplied from the conveying line 12 or a sensor (not shown), after which control goes to step S7. If the control console 18 does not confirm that the vehicle 14 or the carriage 15 has been conveyed in, then the robots 16a, 16b, 16c stay in the standby attitude.

In step S7, the robots 16a, 16b, 16c are operated based on the teaching data to apply the protective layer forming material to the vehicle 14. It is assumed that a vehicle 14 is necessarily placed on a first carriage 15 which is conveyed in after the initial process (step 3).

At this time, matching teaching data are selected and read from the data recorder 602 (see FIG. 20) by referring to the column of “VEHICLE TYPE” in the received production management information 618. The robots 16a, 16b, 16d can thus be controlled depending on the vehicle type. The robots 16a, 16b, 16c can also be controlled to act on vehicles of the same type which may differ as to whether the sunroof opening 14d is present or not, etc.

At this time, the control console 18 controls the regulator control valve 160 through the regulator 158 (see FIG. 11) to control an appropriate pressure to be developed in the coating material pipe 22. The control console 18 also controls the MCV 162 through the MCV switching solenoid-operated valve 166 to connect the coating material pipe 22 and disconnect the water pipe 26. Furthermore, the control console 18 operates the trigger switching solenoid-operated valve 168 to open the trigger valve 164. When the control console 18 is thus operated, the protective layer forming material is supplied to the inner surface of the roller 48 of the roller mechanism 34 while being kept under a suitable pressure and at a suitable temperature. It takes some time for the protective layer forming material which is supplied to the inner surface of the roller 48 to seep out to the surface of the roller 48. However, since the protective layer forming material in the reservoir 420b of the container 420 is sufficiently introduced into in the roller 48 by the preparatory action, the first vehicle 14 can sufficiently and uniformly be coated with the protective layer forming material.

The thickness of the protective layer forming material applied to the vehicle 14 can be adjusted by controlling the pressure with the regulator 158, the speed of operation of the robots 16a, 16b, 16c, and the forces applied to the rods 78a, 80a.

At this time, the vehicle 14 may be an unfinished vehicle with no components mounted thereon insofar as its paint coating has been finished.

The vehicle 14 that has been coated with the protective layer forming material by the robots 16a, 16b, 16c is conveyed to a next station by the conveying line 12. The applied protective layer forming material is dried naturally or by an applied flow of air, forming a peelable protective layer which protects the painted area of the vehicle 14.

In step S8, it is confirmed whether the material filling setting times indicated in the row of “SETTING VALUES” in the material filling time table 442 (see FIG. 12) have elapsed or not. If the material filling setting times have elapsed, then the corresponding timer counters are reset to “0.0”. Thereafter, control goes back to step S4 to perform the preparatory action. If the material filling setting times have not elapsed, then control goes to step S9.

Since control goes back to step S4 if the material filling setting times have elapsed, the protective layer forming material can be supplied by the periodical preparatory action. Therefore, the roller 48 holds the protective layer forming material sufficiently at all times, so that the vehicle 14 is prevented from suffering coating irregularities of the protective layer forming material and coating thickness shortages.

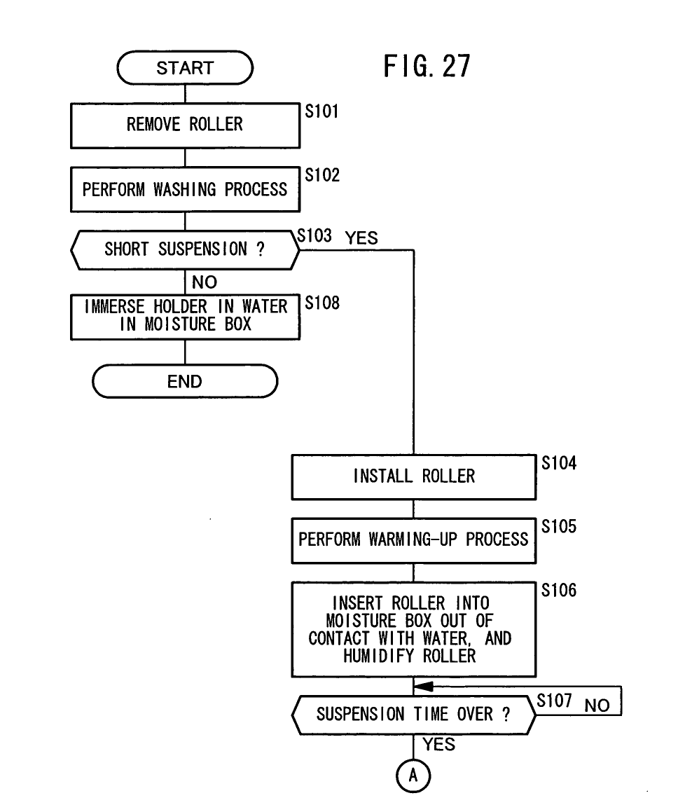

In step S9, it is confirmed whether the washing setting times indicated in the row of “SETTING VALUES” in the washing time table 440 (see FIG. 12) have elapsed or not. If the washing setting times have elapsed, then the corresponding timer counters are reset to “0.0”. Thereafter, control goes to a suspension mode shown in FIG. 27. If the washing setting times have not elapsed, then control goes to step S10.

In step S10, it is confirmed whether a predetermined suspension time is reached or not. If the suspension time is reached, then control goes to the suspension mode shown in FIG. 27. Otherwise, control goes to step S11.

The suspension time is a time when the conveying line 12 is shut off, such as a closing time, a lunch-break start time, or a certain break time in factory operation.

In step S11, the production management information 618 (see FIG. 15) is received from the conveying line control computer 506 (see FIG. 14).

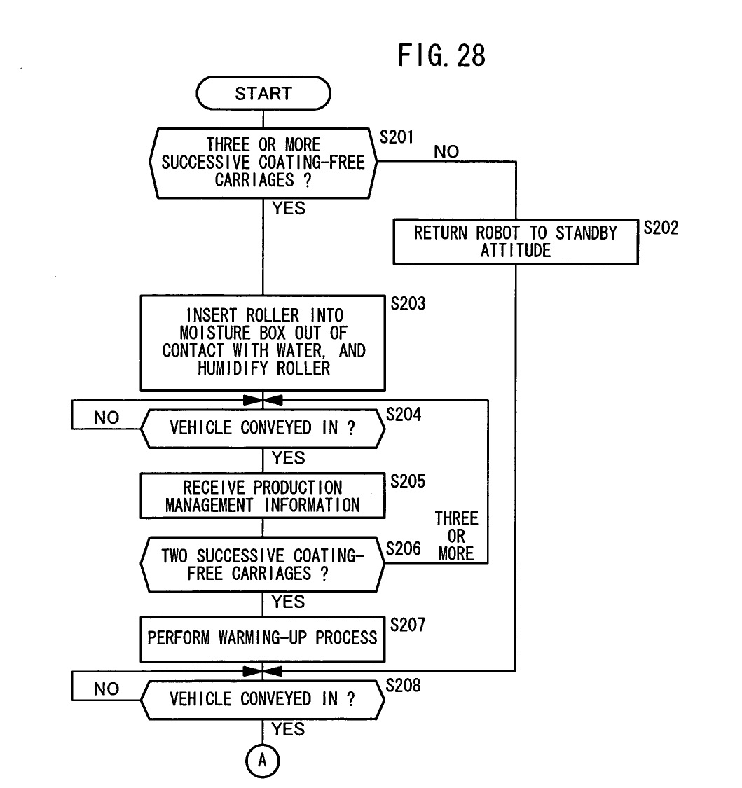

In step S12, it is confirmed whether the vehicle 14 conveyed in at the time is a back-ordered vehicle or an idle carriage 15 (hereinafter referred to as a coating-free carriage), based on the received production management information 618. If the back-order column in the row of the present lot in the production management information 618 indicates “O” or “Δ”, it means that a coating-free carriage will be conveyed in, and control goes to a back-order mode shown in FIG. 28. If the back-order column indicates “-”, then control goes back to step S5.

For example, when the production management information 618 shown in FIG. 15 is received, since the information of the vehicle 14 or the carriage 15 that is conveyed in at the time, i.e., the back-order column in the row of the present lot, indicates “-”, control goes back to step S5. When four vehicles 14 have subsequently passed and the vehicle 14 having the vehicle identification number “17389” is conveyed in, the production management information 618 shown in FIG. 16 is received. Since “O” is recorded in the back-order column in the row of the present lot at this time, control goes to the back-order mode. When “Δ” is recorded in the back-order column, control also goes to the back-order mode.

As described above, using the production management information 618, it is determined whether the vehicle 14 and the carriage 15 that are conveyed in are to be coated with the protective layer forming material or not, for process branching.

In step S12, the type of a next vehicle 14 to be conveyed in is recognized based on the received production management information 618 in preparation for reading corresponding teaching data from the data recorder 602 (see FIG. 20).

In the suspension mode shown in FIG. 27, the robots 16a, 16b, 16c are returned to the standby attitude and the roller 48 is removed from the holder 86 in step S101. The removed roller 48 is washed by a dedicated washing device, and thereafter dried.

In step S102, a washing process is performed. The washing process is a process of operating the MCV 162 through the MCV switching solenoid-operated valve 166 (see FIG. 11) to close the switching valve 162a and open the switching valve 162b. In the washing process, water is supplied from the water pipe 26 to wash the MCV 162, the trigger valve 164, and the tube 22a. The roller 48 may remain attached in step S101, washed by the washing process in step S102, thereafter removed and washed by the dedicated washing device.

In step S103, it is confirmed whether the suspension time corresponds to a short suspension or a long suspension. The short suspension means a suspension time such as a lunch break or a certain break time in factory operation, and the long suspension means a suspension time such as a night time after a closing time. If the suspension time corresponds to a short suspension, then control goes to step S104. If the suspension time corresponds to a long suspension, then control goes to step S108.

In step S104, the roller 48 is installed on the holder 86 as with step S2. The roller 48 is either an unused one or has been washed to drain off any protective layer forming material therefrom.

In step S105, the preparatory action is performed as with step S4. In the preparatory action, the newly installed roller 48 can have the protective layer forming material sufficiently held therein.

In step S106, the second action that has been taught in advance is performed. Specifically, the roller 48 is inserted into the water storage box 430a of the moisture box 430 (see FIG. 10) so as not to contact the water. At this time, the ultrasonic vibrator 430c is vibrated to evaporate the water to keep the interior of the water storage box 430a damp, thereby humidifying the roller 48. The supply of the protective layer forming material is stopped.

The roller 48 may be humidified by evaporating water stored in another region and applying the produced vapor to the roller 48, rather than by the water in the water storage box 430a.

Since the protective layer forming material should desirably be quickly dried and solidified after being applied to the vehicle 14, some protective layer forming material are adjusted so that they can easily be dried and solidified. However, it is disadvantageous if the protective layer forming material is dried and solidified when it is kept in the roller 48 before being applied to the vehicle 14. According to the present embodiment, in a short suspension such as a lunch break or the like, the roller 48 can be humidified using the moisture box 430 to prevent the protective layer forming material from being dried and solidified. Furthermore, because the protective layer forming material is sufficiently kept in the roller 48 in previous step S105, the protective layer forming material can immediately start being applied when the short suspension is over.

If a thermal evaporator is used, it takes some time until it produces vapor. Therefore, it is necessary to generate heat by energizing the thermal evaporator a predetermined time before the roller 48 is inserted into the water storage box 430a, and hence the thermal evaporator consumes a large amount of energy. Moreover, when it is necessary to shut off the conveying line 12 temporarily and humidify the roller 48 quickly, the thermal evaporator may be too late to produce vapor, making it possible for the protective layer forming material held in the roller 48 to be dried and solidified.

Since the moisture box 430 used in the present embodiment is ultrasonically operated, after the roller 48 is inserted into the water storage box 430a, water vapor can quickly be produced by vibrating the ultrasonic vibrator 430c, reliably preventing the protective layer forming material from being dried and solidified. The ultrasonically operated moisture box 430 is effective when there is a need to quickly humidify the roller 48. When the roller 48 is not inserted in the water storage box 430a, the amount of consumed energy is small because the moisture box 430 stops producing water vapor. The moisture box 430 can easily be handled because it does not generate heat unlike the thermal evaporator.

It has been described above that in a short suspension, the roller 48 is washed and replaced, and the preparatory action is carried out in steps S101 through S105. If a short suspension is too short, these steps S101 through S105 may be omitted and control may go to step S106 to humidify the roller 48 used at the time in the moisture box 430. Only the washing and replacing process in steps S101, S102, S104 may be omitted, and after the preparatory action is carried out (step S105), control may go to step S106.

In step S107, the control console 18 confirms whether the suspension time is over or not. At this time, the roller 48 of each of the robots 16a, 16b, 16c remains inserted in the water storage box 430a, and is kept damp by water vapor generated by the ultrasonic vibrator 430c. When the suspension time is over, control goes to step S5. When in the suspension time, the roller 48 is kept as it is. When the suspension time is over, control may return to step S4 to carry out the preparatory action.

In step S8, i.e., when in a long suspension such as a night time, the roller 48 remains detached from the holder 86, and the third action that has been taught in advance is performed. Specifically, the holder 86 is inserted into the water storage box 430a of the moisture box 430 (see FIG. 13), and the tube connector 87 of the holder 86 is immersed in the water in the water storage box 430a. At this time, the ultrasonic vibrator 430c remains shut-off and does not generate water vapor.

By immersing the tube connector 87 in the water, it is prevented from being clogged by the drying and solidification of a certain amount of protective layer forming material which remains trapped in the trigger valve 164 and the tube 22a.

Long suspensions include an ordinary suspension at a night time and a suspension over 24 hours or more such as in a series of holidays. When in a suspension over 24 hours or more, a large amount of water may be stored in the water storage box 430a to immerse the holder 86 deeply in the water. By supplying an amount of water depending on the length of the suspension time, a drop of the water level due to natural evaporation may be compensated for.

The coating process for applying the protective layer forming material is finished in step S108. For restarting the coating system, the coating process is performed from step S1.

In the back-order mode shown in FIG. 28, a process suspension time for suspending the process for applying the protective layer forming material is determined based on the received production management information 618, in step S201. Specifically, it is confirmed whether three or more successive vehicles 14 or carriages 15 that will subsequently be conveyed in from the time are coating-free carriages or not. If three or more vehicles 14 or carriages 15 are coating-free carriages, then it is judged that the process suspension time is long, and control goes to step S203. If one or two successive coating-free carriages will be conveyed in, then it is judged that the process suspension time is short, and control goes to step S502.

Specifically, when even one “-” is recorded in the back-order column in the rows from the present lot to the third lot in the production management information 618, control goes to step S502. When three successive “O” or “Δ” are recorded in the back-order column in the rows from the present lot to the third lot, control goes to step S203. For example, when the production management information 618 shown in FIG. 16 is received, since either “O” or “Δ” is recorded in the back-order column in the rows from the present lot to the fifth lot, control goes to step S203.

As in the suspension mode, periodic suspensions such as a lunch break, a night time, etc. can be recognized by a timer, a clock, or the like. When in such periodic suspensions, the roller 48 can be humidified using the moisture box 430 in order to prevent the protective layer forming material remaining in the roller 48 from being dried and solidified. When coating-free carriages are successively conveyed in, the coating process is suspended. At this time, it is also necessary to prevent the protective layer forming material remaining in the roller 48 from being dried and solidified. However, times at which coating-free carriages are successively conveyed in occur irregularly, such times cannot be determined by a timer or a clock.

According to the present embodiment, since the number of coating-free carriages that will successively be conveyed in can be recognized in advance based on the production management information 618, an appropriate process depending on the recognized number of coating-free carriages can be performed. Specifically, depending on the number of coating-free carriages that will successively be conveyed in, control may be branched to go to either step S502 or step S203.

When three or more coating-free carriages are successively conveyed in, if it is judged that a fixed suspension time (e.g., a lunch break) will be reached during the time in which the last coating-free carriage is conveyed in and out, control may go to step S101 (see FIG. 27) in the suspension mode.

In step S502, the robots 16a, 16b, 16c are returned to the standby attitude, and thereafter control goes to step S508.

In step S203, the roller 48 is inserted into the water storage box 430a of the moisture box 430 (see FIG. 10) so as not to contact the water. At this time, the ultrasonic vibrator 430c is vibrated to evaporate the water to keep the interior of the water storage box 430a damp, thereby humidifying the roller 48. The supply of the protective layer forming material is stopped. The processing in step S203 is the same as the processing in step S106. When three or more coating-free carriages are conveyed in and the process suspension time for stopping the coating process for applying the protective layer forming material is long, since the roller 48 is humidified by the moisture box 430, the protective layer forming material held in the roller 48 is prevented from being dried and solidified.

In step S504, as with step S6, the robots stay in the standby attitude until a vehicle 14 or a carriage 15 is conveyed in. After it is confirmed that a vehicle 14 or a carriage 15 is conveyed in, control goes to step S205.

In step S205, as with step S11, the production management information 618 is received from the conveying line control computer 506.

In step S506, it is determined whether or not a process resumption time until the coating process is resumed is equal to or smaller than a predetermined value, based on the received production management information 618. Specifically, it is determined whether two successive vehicles 14 or carriages 15 that will subsequently be conveyed in from the time are coating-free carriages or not. If two vehicles 14 or carriages 15 are coating-free carriages as indicated in FIG. 17, then control goes to step S207. If three or more successive coating-free carriages will be conveyed in, then control returns to step S504, and the robots stay in the standby attitude until a next vehicle 14 or a next carriage 15 is conveyed in. Specifically, when “-” is recorded in the back-order column in the row of the third lot in the production management information 618, control goes to step S207. When “O” or “Δ” is recorded in the back-order column in the row of the third lot, control goes to step S504.

The branching at step S506 and step S201 is not limited to being judged based on the number of vehicles 14 or carriages 15. The branching may be judged based on a required time that is expected from the number of coating-free carriages. The judgement based on the number of vehicles or carriages and the judgement based on the time are essentially the same as each other.

In step S207, as with step S4, the preparatory action is performed. In this manner, when two successive coating-free carriages are conveyed in, the preparatory action is performed to prepare the coating process for applying the protective layer forming material.

In step S508, as with step S6, the robots stay in the standby attitude until a vehicle 14 or a carriage 15 is conveyed in. After it is confirmed that a vehicle 14 or a carriage 15 is conveyed in, control goes to step S5, bringing the robots 16a, 16b, 16c into the standby attitude.

Thereafter, after the robots have waited for a next vehicle 14 to be conveyed in (step S6), the coating process for applying the protective layer forming material to the vehicle 14 is resumed (step S7). Specifically, by bringing the robots 16a, 16b, 16c into the standby attitude when the last one of coating-free carriages that are successively conveyed in is conveyed in, the coating process for applying the protective layer forming material can be resumed immediately when a next vehicle 14 is conveyed in.

The process shown in FIGS. 26 through 28 is automatically carried out mainly by a program processing sequence of the control console 18, with some auxiliary operations being performed by the worker in charge. Such auxiliary operations include, for example, installing and removing the roller 48 in steps S2, S102, S104. The protective layer forming material and water may be supplied to the container 420 and the water storage box 430a through a visual judgement made by the worker without using the liquid level meters 426, 436, etc.

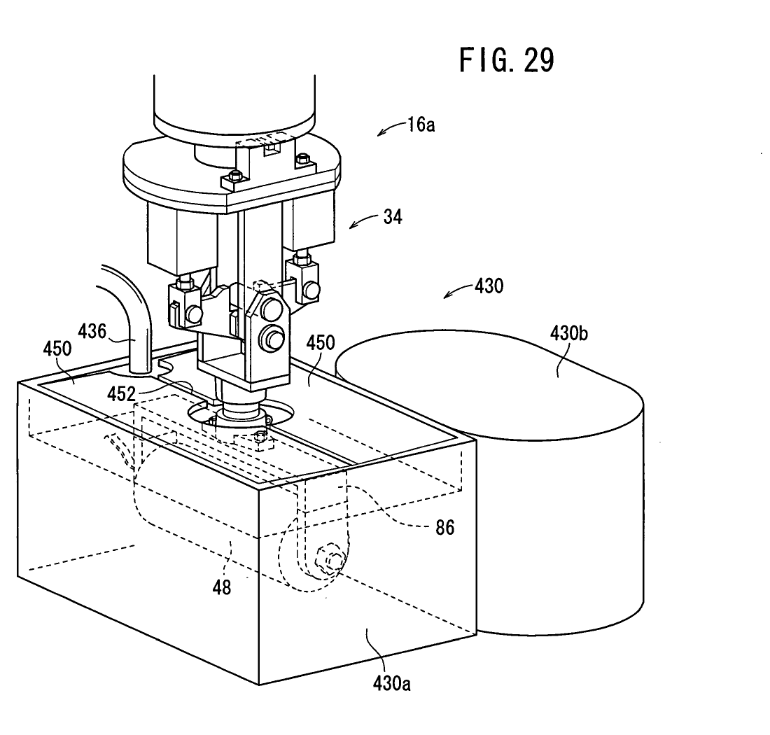

It has been described that the robots 16a, 16b, 16c wait in the standby attitude in step S5. However, as with step S106, the robots may wait while the roller 48 is being inserted in the water storage box 130a of the moisture box 130 and humidified by the water vapor. Though the water storage box 130a has been described being upwardly open, it may have a rubber cover 450 as shown in FIG. 29. In this case, the rubber cover 450 may have a slit 452 for inserting the roller 48 and the holder 86 therethrough. The rubber cover 450 can keep the water storage box 130a damper when water vapor is generated.

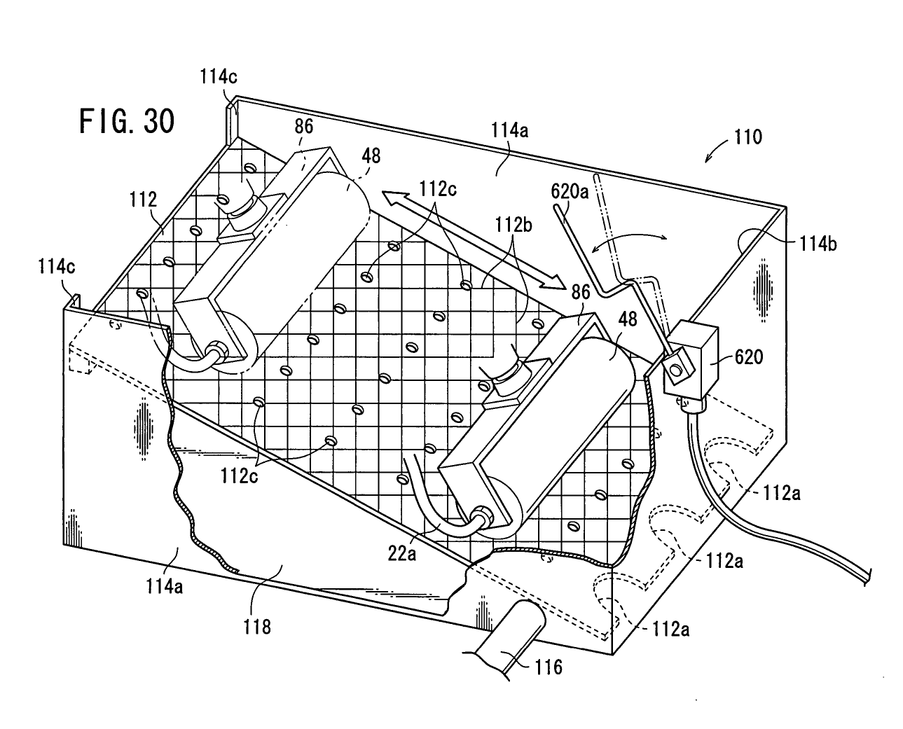

The preparatory action has been described as employing the container 420. However, a preparing mechanism 110 shown in FIG. 30 may be employed instead of the container 420.

As shown in FIG. 30, the preparing mechanism 110 has a width greater than the widths of the roller 48 and the holder 86 which holds the roller 48. The preparing mechanism 110 has a slanted surface 112, side walls 114a attached to two slanted sides of the slanted surface 112, a side wall 114b attached to a lower side of the slanted surface 112, and a discharge port 116 disposed near the lower side. The discharge port 116 may have a removable plug, if necessary. The slanted surface 112 has an upper side having opposite ends supported by small walls 114c. The side walls 114a, 114b and the small walls 114c are connected to a bottom plate 118. The slanted surface 112 comprises an aluminum plate which can easily be installed and removed.

The lower side of the slanted surface 112 has recesses 112a defined therein. The slanted surface 112 has mesh-like convexities 112b entirely thereon and small holes 112c disposed at given intervals.

The slanted surface 112 has a length greater than the diameter of the outer circumference of the roller 48, so that the roller 48 can be rotated through at least 360° when rolling on the slanted surface 112.

A limit switch 620 having a turn lever 620a is mounted on an upper portion of the side wall 114b. The turn lever 620a is inclined toward the slanted surface 112 under a weak resilient force, turning off the limit switch 620. When the turn lever 620a is turned outwardly of the preparing mechanism 110, the limit switch 620 is turned on. A signal indicative of whether the limit switch 620 is turned on or off is supplied through the robot controllers 28a, 28b, 28c to the control console 18.

Actually, the preparing mechanism 110 is of a simple structure constructed of a resin container that is partly machined and an aluminum plate serving as the slanted surface 112 and leaning against the small walls 114c. As the aluminum plate can easily be installed and removed, it may be removed on a timely basis for peeling off the protective layer forming material deposited on its surface. If necessary, the aluminum plate may be washed with water. If the preparing mechanism 110 is placed over a drain pit for discarding the protective layer forming material, then the bottom plate 118 may be dispensed with.

For performing the preparatory action using the preparing mechanism 110, the roller 48 may be rolled on the slanted surface 112 while it is being supplied with the protective layer forming material.

When the robots 16a, 16b, 16c are waiting, the holder 86 may be held against the turn lever 620a. With the holder 86 being held against the turn lever 620a, the worker can centrally manage and recognize when the robots 16a, 16b, 16c are brought into the standby attitude through the monitor screen 18b (see FIG. 1), and also can confirm that the robots 16a, 16b, 16c are operating properly. While the robots are waiting in this attitude, the protective layer forming material dropping from the roller 48 falls onto the slanted surface 112 and does not smear other areas than the preparing mechanism 110.

Since the preparing mechanism 110 does not have a component corresponding to the reservoir 420b, the roller 48 cannot be immersed in the protective layer forming material. However, the protective layer forming material can sufficiently be supplied from the tube 22a to the roller 48.

With the method of applying the protective layer forming material according to the present embodiment, since the production management information 618 is received from the conveying line control computer 506, and the robots 16a, 16b, 16c are controlled based on the production management information 618, the information of vehicles 14 and carriages 15 that will be conveyed in can be recognized in advance, and hence appropriate responses and preparations can be made.

The control console 18 can recognize beforehand the number of coating-free carriages that will be successively conveyed in based on the production management information 618 supplied from the conveying line control computer 506, and hence can determine a process suspension time for the coating process for applying the protective layer forming material. Therefore, when the process suspension time is long, the roller 48 can be humidified by the moisture box 430.

The control console 18 can recognize beforehand when two coating-free carriages will be successively conveyed in based on the production management information 618. In this case, the humidifying process performed by the moisture box 430 is finished, and the preparatory action is performed by the container 420 or the preparing mechanism 110 to prepare the coating process for applying the protective layer forming material.

It has been described that the robots 16a, 16b, 16c wait in the standby attitude in step S5. However, as with step S106, the robots may wait while the roller 48 is being inserted in the water storage box 430a of the moisture box 430 and humidified by the water vapor.

It has been described that the control console 18 of the coating system 10 receives the production management information 618 from the conveying line control computer 506 each time a vehicle 14 or a carriage 15 is conveyed in. However, the control console 18 may receive the production management information 618 at various times. For example, the control console 18 may receive the production management information 618 in real time at each short time interval, may receive the production management information 618 in batches at certain time intervals, or may receive the production management information 618 altogether as daily data at the beginning of operation of the factory.

The production management information 618 is not limited to the format shown in FIGS. 15 through 17, but may be of any format insofar as it represents the recorded relationship between information indicative of whether the protective layer forming material is to be applied to each vehicle 14 or each carriage 15 and operation of the conveying line 12, allowing a process suspension time to be judged.

The control console 18 may edit and generate production management information 618 of its own accord based on predetermined data received from the conveying line control computer 506.

As described above, with the method of and the system 10 for applying the protective layer forming material according to the present embodiment, the protective layer forming material is kept in the reservoir 420b of the container 420, and the preparatory action is performed. Therefore, the protective layer forming material can quickly and sufficiently be caused to seep into the roller 48, and thereafter the coating process can immediately be started. The vehicle 14 is prevented from suffering coating irregularities of the protective layer forming material and coating thickness shortages.

Because the preparatory action is performed after the roller 48 is installed, the protective layer forming material can quickly seep into the roller 48 even if the roller 48 is an unused one or it has been washed, so that the material of the surface of the roller 48 can be rendered soft.

As the preparatory action is performed at each material filling setting time, the sufficient protective layer forming material can be held in the roller 48. The preparatory action may be performed again for each certain number of vehicles 14.

Because the preparatory action is performed while the protective layer forming material is being supplied from the tube 22a to the roller 48, the protective layer forming material can seep more reliably into the roller 48.

With the method of and the system 10 for applying the protective layer forming material according to the present embodiment, when in a long suspension such as a night time, the tube connector 87 is immersed in the water in the water storage box 130a, so that the protective layer forming material remaining in the tube 22a, the trigger valve 164, and the coating material pipe 22 is prevented from being dried and solidified.

When in a short suspension over a short period of time, the roller 48 is placed and humidified in the water storage box 130a, so that the protective layer forming material remaining in the roller 48 is prevented from being dried and solidified. By humidifying the roller 48, the coating process can be started immediately when the coating system is operated again.

According to the present embodiment, the roller mechanism 34 having the roller 48 is operated by the robots 16a, 16b, 16c, and the roller 48 is supplied with the protective layer forming material. Therefore, the process of applying the protective layer forming material is automated, and the coating quality is uniformized.

The process of applying the protective layer forming material to the surface of the vehicle 14 can be made more automatic than the conventional process.

As the worker does not need to apply the protective layer forming material because of the automated process, the number of process steps is reduced for increased production efficiency, and an air-conditioning system for the worker is dispensed with. Because no electric energy is required for such an air-conditioning system, the coating system is an energy saver, is more environment-friendly, and reduces the operating cost of the factory.

The peelable protective layer that is formed from the protective layer forming material is effective to protect the painted area of the vehicle 14 after the vehicle 14 is shipped, and can be used as a substitute for a scratch cover because the peelable protective layer protects the painted area in the factory. Therefore, many scratch covers having different shapes for different vehicle types can be dispensed with.

Some bumpers of vehicles 14 are colored and do not need to be painted. The protective layer forming material may be applied to areas other than painted areas such as bumpers.

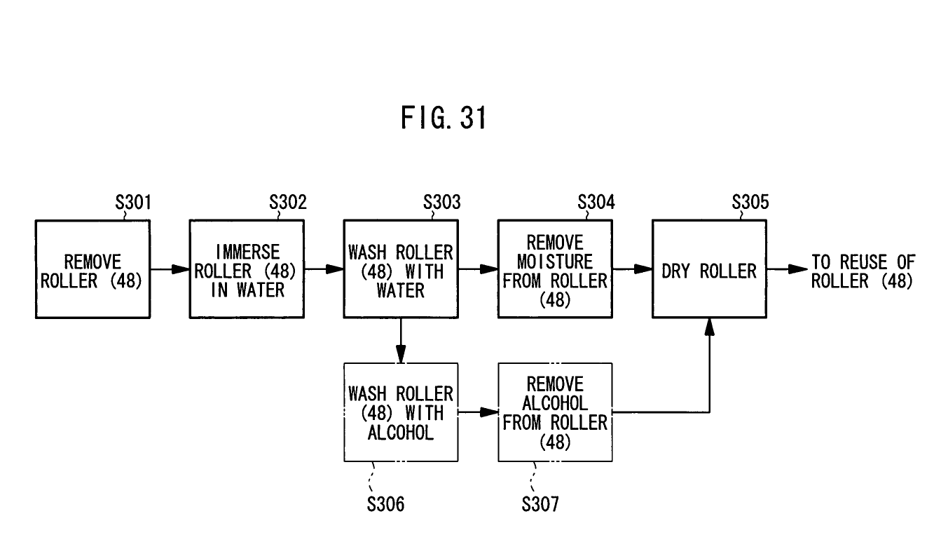

The process of washing the roller 48 will be described below with reference to FIG. 31.

In step S301, the roller 48 is removed from the holder 86 of the roller mechanism 34 of each of the robots 16a, 16b, 16c. Step S301 corresponds to step S101 described above.

In step S302, the roller 48 is immersed in water (cleaning liquid) stored in a general washing tank, for example.

In step S303, the roller 48 is washed with the water in the washing tank. It is more effective to wash the roller 48 with running water.

In step S304, the moisture in the roller 48 which has been washed with the water is removed by a dehydrator or by swinging the roller 48. The dehydrator may be of the type in which air is applied circumferentially to the roller 48 to rotate the rotor 48 about its own axis at a high speed.

In step S5, the roller 48 is dried. The dried roller 48 is immediately reused (see step S2 in FIG. 26) or stored for reuse. The roller 48 may be dried by a drier or may be dried naturally.

The above washing process should desirably be performed periodically. According to the present embodiment, the washing process is carried out in at least every 72 hours. The time interval for the washing process can be set to a suitable value such as every 24 hours or every 48 hours, depending on the number of vehicles 14 to be manufactured or the frequency with which the roller 48 is used.

The cycle of the above steps may be performed concurrently for a plurality of rollers 48 while keeping the steps of the cycles out of synchronism with each other. According to this process, the robots 16a through 16b do not need to wait until the steps of washing and drying the roller 48 are over, and can continue the coating process with the washed and dried rollers installed thereon.

If the protective layer forming material is applied as a semi-solid deposit on the roller 48, the roller 48 should preferably be washed with alcohol (auxiliary washing liquid) or the like after step S303. Specifically, as shown in FIG. 31, in step S306, the roller 48 is washed in a general alcohol washing tank which is supplied with and stores alcohol. The alcohol may be ethanol or isopropanol alcohol. In this manner, even if the protective layer forming material is applied as a semi-solid deposit on the roller 48, it can effectively be washed away.

In step S307, alcohol remaining in the roller 48 which has been washed with the alcohol is removed by a dehydrator or by swinging the roller 48. Thereafter, the roller 48 is dried in step S305. The dried roller 48 is immediately reused or stored for reuse.

As described above, after the coating process for applying the protective layer forming material to the vehicle 14 is finished, the roller 48 is washed with water or alcohol to suppress any deterioration thereof as much as possible. Therefore, the performance of the roller 48 can be maintained for a long period of time. As a result, the roller 48 can have a longer service life.

If the above washing process is performed in every 72 hours, for example, the performance of the roller 48 can be maintained for a longer period of time.

1. A system for applying a protective layer forming material, comprising:
a coating apparatus disposed near a conveying line for successively conveying a plurality of workpieces on carriages, said coating apparatus being operable based on teaching data;
a roller mechanism connected to said coating apparatus and having a removable roller;
a supply mechanism for supplying a protective layer forming material in a liquid form which will act as a peelable protective layer after being dried;
a production management information supply for holding production management information representing the recorded relationship between information about each of said workpieces and operation of said conveying line; and
a control console connected to said production management information supply, for receiving said production management information and controlling said coating apparatus;
wherein said control console controls said coating apparatus based on said production management information.

2. A system according to claim 1, wherein said coating apparatus comprises a robot, and each of said workpieces comprises a vehicle.

3. A system according to claim 1, wherein said production management information includes information indicative of the types of said workpieces; and
said control console selects said teaching data based on said information indicative of the types of said workpieces, and operates said coating apparatus.

4. A system according to claim 1, further comprising:
a water reservoir disposed in an operation range of said coating apparatus and storing a washing liquid; and
a vapor generator for evaporating or atomizing said washing liquid stored in said water reservoir;
wherein said production management information includes information indicative of whether said protective layer forming material is to be applied to each of said workpieces or said carriages; and
said production management information supply or said control console determines a process suspension time to suspend a coating process for applying said protective layer forming material based on said production management information, and, if said process suspension time is equal to or greater than a predetermined value, controls said vapor generator to evaporate or atomize said washing liquid in said water reservoir and apply generated vapor to said roller to humidify said roller.

5. A system according to claim 4, wherein said control console recognizes the number of successively conveyed workpieces or carriages which are not to be coated with said protective layer forming material, based on said production management information, and determines said process suspension time based on the recognized number.

6. A system according to claim 4, further comprising:
a planar surface on which said roller rolls, said planar surface being disposed in the operation range of said coating apparatus and wider than a longitudinal width of said roller;
wherein said control console determines a process resumption time until said coating process is resumed based on said production management information, and, if said process resumption time is equal to or smaller than a predetermined value, moves said roller from said vapor generator to said planar surface, and rolls said roller on said planar surface while supplying said protective layer forming material to said roller.

7. A system according to claim 4, wherein said vapor generator comprises an ultrasonic vibrator which is vibratable for evaporating or atomizing said washing liquid.

8. A system according to claim 1, wherein said supply mechanism has a pressure control valve for controlling the pressure of said protective layer forming material supplied to said roller; and
said control console supplies said protective layer forming material while changing the pressure of said protective layer forming material when said workpieces are coated with said protective layer forming material.

9. A system according to claim 8, wherein a surface of said workpieces which is to be coated with said protective layer forming material is divided into a plurality of coating areas, and said control console controls the pressure to supply said protective layer forming material with respect to each of said coating areas.

10. A system according to claim 9, wherein said control console controls respective times to supply said protective layer forming material to said coating areas.

11. A system according to claim 9, wherein said workpieces conveyed by said conveying line have a plurality of types; and
said control console has an identifier for identifying the types of said workpieces; and
a recorder for recording information about the division of said coating areas and pressures to supply said protective layer forming material for the respective coating areas, with respect to each of the types of said workpieces;
wherein said control console identifies the types of said workpieces with said identifier, reads the information corresponding to the types, and controls the pressures to supply said protective layer forming material.

12. A system according to claim 8, wherein said roller comprises:
an outer protective layer forming material absorbing and holding member;
a pipe disposed axially and having a plurality of holes defined in an outer circumferential surface thereof for supplying said protective layer forming material; and
a hollow cylindrical collar disposed between said protective layer forming material absorbing and holding member and said pipe;
wherein said collar has conductive holes for leading said protective layer forming material supplied from said holes in said pipe to said protective layer forming material absorbing and holding member.

13. A system according to claim 1, wherein said protective layer forming material comprises an acrylic copolymer.

14. A method of applying a protective layer forming material, comprising:
the first step of applying said protective layer forming material to workpieces, using:
a coating apparatus disposed near a conveying line for successively conveying a plurality of workpieces on carriages, said coating apparatus being operable based on teaching data;
a roller mechanism connected to said coating apparatus and having a removable roller; and
a supply mechanism for supplying said protective layer forming material in a liquid form which will act as a peelable protective layer after being dried;
the second step of removing said roller from said roller mechanism after said first step is finished;
the third step of immersing said roller removed from said roller mechanism into a washing liquid;
the fourth step of washing said roller immersed in said washing liquid, with said washing liquid;
the fifth step of removing said washing liquid from said roller which has been washed with said washing liquid;
the sixth step of drying said roller; and
the seventh step of reinstalling said roller which has been dried on said roller mechanism.

15. A method according to claim 14, wherein said coating apparatus comprises a robot, and each of said workpieces comprises a vehicle.

16. A method according to claim 14, wherein a cycle of said first through seventh steps is performed concurrently for a plurality of rollers while keeping the steps out of synchronism with each other.

17. A method according to claim 14, wherein a cycle of said first through seventh steps is performed within 72 hours.

18. A method according to claim 14, wherein in said fourth step, said roller is washed with said washing liquid and washed with an auxiliary washing liquid which is different from said washing liquid.

19. A method according to claim 18, wherein said washing liquid comprises water and said auxiliary washing liquid comprises alcohol.

20. A method according to claim 14, wherein a planar surface on which said roller rolls, said planar surface being disposed in an operation range of said coating apparatus and wider than a longitudinal width of said roller, and a reservoir disposed in the operation range of said coating apparatus and storing said protective layer forming material, are employed, and wherein said first step comprises:
the first substep of immersing said roller in said protective layer forming material stored in said reservoir; and
the second substep of rolling said roller on said planar surface.

21. A method according to claim 20, wherein said roller is removably mounted on said coating apparatus, and said first substep and said second substep are carried out again when said roller is replaced.

22. A method according to claim 20, wherein while said first step is being carried out, said first substep and said second substep are carried out again for a predetermined number of said workpieces or at each predetermined time interval.

23. A method according to claim 20, wherein said first substep and/or said second substep is carried out while said protective layer forming material is being supplied from said supply mechanism to said roller.

24. A method according to claim 14, wherein a water reservoir disposed in an operation range of said coating apparatus and storing said washing liquid is employed, and in a suspension time after said roller is removed from said roller mechanism in said second step and until a replacing roller is installed on said roller mechanism, a protective layer forming material support port which is supplied with said protective layer forming material in a mount of said roller is immersed in said washing liquid in said water reservoir.

25. A method according to claim 14, wherein a water reservoir disposed in an operation range of said coating apparatus and storing said washing liquid, and a vapor generator for evaporating or atomizing said washing liquid stored in said water reservoir are employed, and wherein in a predetermined suspension time in said first step, said roller is positioned above the liquid level of said washing liquid in said water reservoir, and said vapor generator evaporates or atomizes said washing liquid to humidify said roller.

26. A method according to claim 14, wherein said vapor generator comprises an ultrasonic vibrator which is vibratable for evaporating or atomizing said washing liquid.

27. A method according to claim 14, wherein said protective layer forming material comprises an acrylic copolymer.
